(19) United States
(12) Patent Application Publication
(10) Pub. No.: US 2026/0011134 A1
(43) Pub. Date: Jan. 8, 2026

(54) SYSTEMS AND METHODS FOR USING A MACHINE LEARNING ARCHITECTURE TO GENERATE IMAGES AND LABELS

(71) Applicant: Barbershop Books, New York, NY (US)

(72) Inventor: Alvin Irby, New York, NY (US)

(73) Assignee: Barbershop Books, New York, NY (US)

(21) Appl. No.: 19/261,732

(22) Filed: Jul. 7, 2025

Related U.S. Application Data
(60) Provisional application No. 63/668,738, filed on Jul. 8, 2024.

(51) Int. Cl. G06V 10/82; G06F 3/04842; G06V 10/774; G06V 10/778

(52) U.S. Cl. CPC G06V 10/82; G06F 3/04842; G06V 10/774; G06V 10/7788

(57) ABSTRACT

A method can include storing a plurality of images and labels corresponding to the plurality of images; generating a sequence of sets of images from the plurality of images on a user interface at a user device; receiving a selection of an image for each of the sets of images from the user device; determining a user configuration for a user based on the selections of the images and the labels corresponding to the selected images; creating a training set; and training a neural network to generate images and labels corresponding to the images using the training set.

### CROSS REFERENCE TO RELATED APPLICATIONS

This application claims the benefit of priority U.S. Provisional Application No. 63/668,738, filed Jul. 8, 2024, the entirety of which is incorporated by reference in its entirety.

### TECHNICAL FIELD

This application relates generally to generating, training, and operating machine learning models for image and content generation.

### BACKGROUND

Digital content systems have grown increasingly complex as the volume of available content has expanded exponentially. Users are presented with vast libraries of text, images, and multimedia materials, making it difficult to identify content that matches their individual preferences and interests. Traditional content delivery methods often rely on basic categorization schemes or simple filtering mechanisms that may not capture the nuanced nature of user preferences. As content repositories have grown larger, there has been an increasing need for more sophisticated approaches to help users discover relevant materials. These systems need to be capable of processing various types of user input and interaction data to better understand what content might be of interest to different individuals.

Current content systems face several challenges in effectively matching users with appropriate materials. Many existing approaches operate with limited information about user preferences, making it difficult to provide personalized recommendations or generate content that aligns with individual interests. Furthermore, conventional systems often treat different types of user data separately, without leveraging the potential benefits of combining multiple information sources. There is a recognized need in the field for improved methods of understanding user preferences, generating relevant content, and providing personalized recommendations that can adapt and improve over time. The development of more effective content systems remains an active area of research and development, with ongoing efforts to create better user experiences through enhanced personalization and content matching capabilities.

### SUMMARY

For the aforementioned reasons, there is a desire for an improved software solution and computer-implemented technique that integrates machine learning for enhanced content generation and contextual recommendation systems. In particular, there is a need for systems that can accurately determine user preferences for various types of content, such as specific user configurations. There is a need to develop a comprehensive system that can analyze user interactions with visual content, incorporate contextual information such as geographical location and user attributes, and use generative models (e.g., neural networks) to generate targeted content and recommendations based on predicted user preferences, thereby improving accuracy of preference determination and the relevance of the generated content. The systems additionally reduce the computational overhead and improve processing efficiency of generative recommendation and content systems compared to systems that implement traditional survey-based or brute-force recommendation approaches.

The systems and methods described herein address these technical challenges through a series of integrated methods that implement machine learning models to process multimodal user interaction data for improved contextual content recommendations and generation. For instance, the system can present sequences of image sets to users and analyze their selections along with corresponding labels to train neural networks to predict user configurations and generate contextually relevant content (e.g., images that can subsequently be used for user configuration predictions). By incorporating geographical location information, user attributes, and demographic data into the training process, the system can create comprehensive user profiles that enable accurate preference prediction across diverse populations. The system can utilize generative machine learning models, such as large language models, generative adversarial networks, and/or diffusion models, to create new images and content based on learned user preferences, while simultaneously implementing ranking algorithms that organize content according to predicted preference scores. Finally, the systems integrate natural language processing capabilities to extract keywords from spoken utterances, enabling voice-based preference determination that complements visual selection data. Through continuous monitoring of user actions and adaptive weight assignment mechanisms, the system can create feedback loops that improve prediction accuracy over time while maintaining computational efficiency through optimized neural network architectures and streamlined data processing workflows.

In an embodiment, a method comprises storing, by one or more processors, a plurality of images and labels corresponding to the plurality of images, each label indicating content of an image corresponding to the label; presenting, by the one or more processors, a sequence of sets of images from the plurality of images on a user interface at a user device; receiving, by the one or more processors, a selection of an image for each set of the sets of images from the user device; determining, by the one or more processors, a predicted user configuration for a user of the user device based on the selections of the images and the labels corresponding to the selected images; creating, by the one or more processors, a training set at least comprising the selections of the images, the labels corresponding to the selected images, the predicted user configuration for the user, and an expected user configuration for the user; and training, by the one or more processors, a machine learning model to generate images and labels corresponding to the images using the training set based at least on the selections of the images, the labels corresponding to the selected images, and a comparison of the predicted user configuration and the expected user configuration.

In another embodiment, a system comprises one or more processors coupled with memory. The one or more processors can be configured to store a plurality of images and labels corresponding to the plurality of images, each label indicating content of an image corresponding to the label; present a sequence of sets of images from the plurality of images on a user interface at a user device; receive a selection of an image for each set of the sets of images from the user device; determine a predicted user configuration for a user of the user device based on the selections of the images and the labels corresponding to the selected images; create a training set at least comprising the selections of the images, the labels corresponding to the selected images, the predicted user configuration for the user, and an expected user configuration for the user; and train, using the training set, a neural network to generate images and labels corresponding to the images based at least on the selections of the images, the labels corresponding to the selected images, and a comparison of the predicted user configuration and the expected user configuration.

In another embodiment, a non-transitory computer readable medium including computer readable instructions, that when executed by one to more processors, cause the one or more processors to store a plurality of images and labels corresponding to the plurality of images, each label indicating content of an image corresponding to the label; present a sequence of sets of images from the plurality of images on a user interface at a user device; receive a selection of an image for each set of the sets of images from the user device; determine a predicted user configuration for a user of the user device based on the selections of the images and the labels corresponding to the selected images; create a training set at least comprising the selections of the images, the labels corresponding to the selected images, the predicted user configuration for the user, and an expected user configuration for the user; and train, using the training set, a neural network to generate images and labels corresponding to the images based at least on the selections of the images, the labels corresponding to the selected images, and a comparison of the predicted user configuration and the expected user configuration.

In another embodiment, a method comprises storing, by one or more processors, a plurality of images and labels corresponding to the plurality of images in a database, each label indicating content of an image corresponding to the label; identifying, by the one or more processors, attributes associated with a first user of a first user device and a second user of a second user device; presenting, by the one or more processors, a first sequence of sets of images from the plurality of images and labels corresponding to each image in the first sequence of sets of images on a first user interface of the first user device, the first sequence of sets of images determined based on the attributes associated with the first user; receiving, by the one or more processors, a selection of an image from the first sequence of sets of images, from the first user device; determining, by the one or more processors, a second sequence of sets of images based on the selection of the image from the first sequence of sets of images at the first user device and the attributes of the second user; and presenting, by the one or more processors, the second sequence of sets of images and labels corresponding to the second sequence of sets of images on a second user interface on the second user device.

In another embodiment, a system comprises one or more processors coupled with memory. The one or more processors can be configured to store a plurality of images and labels corresponding to the plurality of images in a database, each label indicating content of an image corresponding to the label; identify attributes associated with a first user of a first user device and a second user of a second user device; present a first sequence of sets of images from the plurality of images and labels corresponding to each image in the first sequence of sets of images on a first user interface of the first user device, the first sequence of sets of images determined based on the attributes associated with the first user; receive, a selection of an image from the first sequence of sets of images, from the first user device; determine a second sequence of sets of images based on the selection of the image from the first sequence of sets of images at the first user device and the attributes of the second user; and present the second sequence of sets of images and labels corresponding to the second sequence of sets of images on a second user interface on the second user device.

In another embodiment, a non-transitory computer readable medium including computer readable instructions, that when executed by one to more processors, cause the one or more processors to store a plurality of images and labels corresponding to the plurality of images in a database, each label indicating content of an image corresponding to the label; identify attributes associated with a first user of a first user device and a second user of a second user device; present a first sequence of sets of images from the plurality of images and labels corresponding to each image in the first sequence of sets of images on a first user interface of the first user device, the first sequence of sets of images determined based on the attributes associated with the first user; receive, a selection of an image from the first sequence of sets of images, from the first user device; determine a second sequence of sets of images based on the selection of the image from the first sequence of sets of images at the first user device and the attributes of the second user; and present the second sequence of sets of images and labels corresponding to the second sequence of sets of images on a second user interface on the second user device.

In another embodiment, a method comprises storing, by one or more processors, a plurality of images and labels corresponding to the plurality of images, each label indicating content of an image corresponding to the label; monitoring, by the one or more processors, one or more user actions performed via an application executing on a first client device, the application configured to present sequences of sets of images selected from the plurality of images for user configuration determination, and the one or more user actions corresponding to one or more adjustments to the sequences of sets of images; executing, by the one or more processors, a generative machine learning model to generate images and labels indicating the content of the generated images, the generative machine learning model trained based on the monitored one or more user actions performed via the application; and presenting, by the one or more processors, the generated images and labels on a user interface of a second client device.

In another embodiment, a system comprises one or more processors coupled with memory. The one or more processors can be configured to store a plurality of images and labels corresponding to the plurality of images, each label indicating content of an image corresponding to the label; monitor one or more user actions performed via an application executing on a first client device, the application configured to present sequences of sets of images selected from the plurality of images for user configuration determination, and the one or more user actions corresponding to one or more adjustments to the sequences of sets of images; execute a generative machine learning model to generate images and labels indicating the content of the generated images, the generative machine learning model trained based on the monitored one or more user actions performed via the application; and present the generated images and labels on a user interface of a second client device.

In another embodiment, a non-transitory computer readable medium including computer readable instructions, that when executed by one to more processors, cause the one or more processors to store a plurality of images and labels corresponding to the plurality of images, each label indicating content of an image corresponding to the label; monitor one or more user actions performed via an application executing on a first client device, the application configured to present sequences of sets of images selected from the plurality of images for user configuration determination, and the one or more user actions corresponding to one or more adjustments to the sequences of sets of images; execute a generative machine learning model to generate images and labels indicating the content of the generated images, the generative machine learning model trained based on the monitored one or more user actions performed via the application; and present the generated images and labels on a user interface of a second client device.

In another embodiment, a method comprises extracting, by one or more processors, a plurality of content items from a data repository, each of the plurality of content items corresponding to a set of attributes describing content of each content item of the plurality of content items; generating, by one or more processors, a first arrangement of identifications of the plurality of content items on a user interface presented at a user device; receiving, by one or more processors from a user device, a set of user configurations of a user; executing, by the one or more processors, a machine learning model using the set of user configurations, the plurality of content items, and the set of attributes for each of the plurality of content items to generate a user configuration score for each of the plurality of content items; ranking, by the one or more processors, the plurality of content items according to the user configuration score generated by the machine learning model; determining, by the one or more processors, a second arrangement indicating an order to present the identifications of the plurality of content items on the user interface according to the rankings of the plurality of content items, the order indicating a plurality of positions on the user interface; automatically moving, by the one or more processors, each of the identifications of the plurality of content items presented on the user interface from the first arrangement to the second arrangement based on a corresponding position of the plurality of positions.

In another embodiment, a system comprises one or more processors coupled with memory. The one or more processors can be configured to extract a plurality of content items from a data repository, each of the plurality of content items corresponding to a set of attributes describing content of each content item of the plurality of content items; generate a first arrangement of identifications of the plurality of content items on a user interface presented at a user device; receive, from a user device, a set of user configurations of a user; extract a plurality of content items from a data repository, each of the plurality of content items corresponding to a set of attributes describing content of each content item of the plurality of content items; execute a machine learning model using the set of user configurations, the plurality of content items, and the set of attributes for each of the plurality of content items to generate a user configuration score for each of the plurality of content items; rank the plurality of content items according to the user configuration score generated by the machine learning model; determine a second arrangement indicating an order to present the identifications of the plurality of content items on the user interface according to the rankings of the plurality of content items, the order indicating a plurality of positions on the user interface; and automatically move each of the identifications of the plurality of content items presented on the user interface from the first arrangement to the second arrangement based on a corresponding position of the plurality of positions.

In another embodiment, a non-transitory computer readable medium including computer readable instructions, that when executed by one to more processors, cause the one or more processors to extract a plurality of content items from a data repository, each of the plurality of content items corresponding to a set of attributes describing content of each content item of the plurality of content items; generate a first arrangement of identifications of the plurality of content items on a user interface presented at a user device; receive, from a user device, a set of user configurations of a user; extract a plurality of content items from a data repository, each of the plurality of content items corresponding to a set of attributes describing content of each content item of the plurality of content items; execute a machine learning model using the set of user configurations, the plurality of content items, and the set of attributes for each of the plurality of content items to generate a user configuration score for each of the plurality of content items; rank the plurality of content items according to the user configuration score generated by the machine learning model; and determine a second arrangement indicating an order to present the identifications of the plurality of content items on the user interface according to the rankings of the plurality of content items, the order indicating a plurality of positions on the user interface; and automatically move each of the identifications of the plurality of content items presented on the user interface from the first arrangement to the second arrangement based on a corresponding position of the plurality of positions.

In another embodiment, a method comprises receiving, by one or more processors for each of a plurality of first users, a set of user configurations and a first set of attributes associated with a first user; generating, by the one or more processors for each of the plurality of first users, a first profile comprising the set of user configurations and the first set of attributes associated with the first user; generating, by the one or more processors, a sequence of sets of images for presentation on a user interface at a client device accessing a second profile, each image corresponding to a user configuration and the second profile corresponding to a second set of attributes associated with a second user; receiving, by the one or more processors from the user interface, a selection of an image from each set of the sequence of sets; executing, by the one or more processors, a generative machine learning model using the second set of attributes associated with the second user and identifications of the selections of the images to generate an identification content for the second user, the generative machine learning model trained based on first profiles for the plurality of first users and image selections by the plurality of first users using the first profiles; and revising, by the one or more processors, the user interface presented at the client device to include the identification of the content for the second user.

In another embodiment, a system comprises one or more processors coupled with memory. The one or more processors can be configured to receive for each of a plurality of first users, a set of user configurations and a first set of attributes associated with a first user; generate for each of the plurality of first users, a first profile comprising the set of user configurations and the first set of attributes associated with the first user; generate a sequence of sets of images for presentation on a user interface at a client device accessing a second profile, each image corresponding to a user configuration and the second profile corresponding to a second set of attributes associated with a second user; receive, from the user interface, a selection of an image from each set of the sequence of sets; execute a generative machine learning model using the second set of attributes associated with the second user and identifications of the selections of the images to generate identifications of content for the second user, the generative machine learning model trained based on first profiles for the plurality of first users and image selections by the plurality of first users using the first profiles; and revise the user interface presented at the client device to include the identification of the content for the second user.

In another embodiment, a non-transitory computer readable medium including computer readable instructions, that when executed by one to more processors, cause the one or more processors to receive for each of a plurality of first users, a set of user configurations and a first set of attributes associated with a first user; generate for each of the plurality of first users, a first profile comprising the set of user configurations and the first set of attributes associated with the first user; generate a sequence of sets of images for presentation on a user interface at a client device accessing a second profile, each image corresponding to a user configuration and the second profile corresponding to a second set of attributes associated with a second user; receive, from the user interface, a selection of an image from each set of the sequence of sets; execute a generative machine learning model using the second set of attributes associated with the second user and identifications of the selections of the images to generate identifications of content for the second user, the generative machine learning model trained based on first profiles for the plurality of first users and image selections by the plurality of first users using the first profiles; and revise the user interface presented at the client device to include the identification content for the second user.

In another embodiment, a method comprises receiving, by one or more processors, an utterance comprising a plurality of words from a user device, the utterance transcribed based on audio data of an individual speaking into a microphone; executing, by the one or more processors, a natural language processing model to extract a plurality of keywords from the utterance; executing, by the one or more processors, a machine learning model using the extracted plurality of keywords from the utterance to generate one or more user configurations, the machine learning model trained to generate the one or more user configurations based on a training set of keywords mapped to user configurations; and generating, by the one or more processors, the one or more user configurations for presentation on a user interface of the user device with mappings between the one or more user configurations and corresponding keywords extracted from the utterance.

In another embodiment, a system comprises one or more processors coupled with memory. The one or more processors can be configured to receive an utterance comprising a plurality of words from a user device, the utterance transcribed based on audio data of an individual speaking into a microphone; execute a natural language processing model to extract a plurality of keywords from the utterance; execute a machine learning model using the extracted plurality of keywords from the utterance to generate one or more user configurations, the machine learning model trained to generate the one or more user configurations based on a training set of keywords mapped to user configurations; and generate the one or more user configurations for presentation on a user interface of the user device with mappings between the one or more user configurations and corresponding keywords extracted from the utterance.

In another embodiment, a non-transitory computer readable medium including computer readable instructions, that when executed by one to more processors, cause the one or more processors to receive an utterance comprising a plurality of words from a user device, the utterance transcribed based on audio data of an individual speaking into a microphone; execute a natural language processing model to extract a plurality of keywords from the utterance; execute a machine learning model using the extracted plurality of keywords from the utterance to generate one or more user configurations, the machine learning model trained to generate the one or more user configurations based on a training set of keywords mapped to user configurations; and generate the one or more user configurations for presentation on a user interface of the user device with mappings between the one or more user configurations and corresponding keywords extracted from the utterance.

### BRIEF DESCRIPTION OF THE DRAWINGS

Non-limiting embodiments of the present disclosure are described by way of example with reference to the accompanying figures, which are schematic and are not intended to be drawn to scale. Unless indicated as representing the background art, the figures represent aspects of the disclosure.

FIG. 1 illustrates components of an artificial intelligence (ML) enabled electronic image and preference management system, according to an embodiment.

FIG. 2 illustrates an example of a user interface showing images and labels extracted from a database, according to an embodiment.

FIGS. 3-6 illustrates examples of a user interface showing generated images and labels for the generated images, according to an embodiment.

FIGS. 7-10 illustrates examples of the user interface showing the generated images, the labels for the generated images, and selections for the images, in accordance with an embodiment.

FIG. 11 illustrates an example of the user interface showing a dashboard with generated profiles for each student, in accordance with an embodiment.

FIG. 12 illustrates a flow diagram of a method for using ML to generate images and labels for students, in accordance with an embodiment.

FIG. 13 illustrates a flow diagram of a method for using ML to generate images and labels for students and teachers, in accordance with an embodiment.

FIG. 14 illustrates a flow diagram of a method for using ML to determine images and labels to teachers as a default for instruction, in accordance with an embodiment.

FIG. 15 illustrates a flow diagram of a method for using ML to analyze items in a content repository to produce a ranked list of item recommendations, in accordance with an embodiment.

FIG. 16 illustrates a flow diagram of a method for using profiles for students as an input to ML to generate recommendations for user configurations, in accordance with an embodiment.

FIG. 17 illustrates a flow diagram of a method for using words spoken by students as an input to ML to determine user configurations of users, in accordance with an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting of the subject matter presented.

Modern content generation and contextual recommendation systems face significant technical difficulties in creating and delivering personalized content and recommendations that accurately match individual user preferences and contextual requirements. These systems process large amounts of heterogeneous data, including user interaction patterns, demographic information, geographical context, and behavioral signals, while simultaneously generating new content and ranking existing materials according to predicted user interests. To achieve effective personalization at scale, these systems rely on sophisticated machine learning architectures that can learn from diverse data sources and adapt to changing user behaviors. However, the computational complexity of training such models on multimodal datasets, combined with the need for real-time preference inference and content adaptation, creates substantial technical challenges in achieving both accuracy and efficiency. Additional complexity arises from the dynamic nature of user preferences that evolve over time, the requirement to incorporate feedback from multiple interaction modalities, and the need to scale personalization algorithms across diverse user populations with varying cultural and geographical contexts.

The technical challenges addressed by the present disclosure stem from fundamental limitations in how typical content recommendation and generation systems process multimodal user data and determine accurate user preferences. Conventional systems often rely on isolated data sources, such as explicit user ratings or demographic information, without effectively integrating visual selection patterns, contextual information, and behavioral data to create comprehensive preference profiles. This fragmented approach to data processing results in irrelevant content recommendations and inefficient use of available user interaction data, leading to poor user engagement and wasted computational resources in generating irrelevant content. Moreover, existing systems often lack robust systems for adapting to the evolving nature of user preferences and do not leverage the full potential of machine learning architectures for personalized content generation and recommendations.

A technical solution to the aforementioned technical problems includes a method for contextual image generation that addresses the problem of training neural networks with insufficient contextual data for preference prediction. To do so, a system can present sequences of image sets to users, collect their selections along with corresponding labels, and incorporate geographical location information and user attributes into the training process. By comparing predicted user configurations with expected preferences and using this comparison as part of the training dataset, the neural network learns to generate images and labels that are more likely to accurately reflect user preferences. This approach solves the technical problem of sparse training data by creating contextual datasets that improve the accuracy of preference prediction models while enabling the generation of new content that can be tailored to specific user populations and geographical regions.

Another technical solution to the aforementioned technical problems addresses the challenge of cross-user preference transfer and attribute-based content customization. The system can identify attributes associated with different users, present customized sequences of images to a first user based on their attributes, and then use the first user's selections combined with a second user's attributes to determine appropriate content for the second user. This method can resolve the technical problem of cold-start recommendations for new users or users with limited interaction history by leveraging the selection patterns of similar users while accounting for individual attribute differences. The system can implement dynamic weight assignment mechanisms that adjust or change based on user selections, enabling more accurate cross-user preference inference and reducing the computing resources that are needed for generating personalized content for individual users.

Another technical solution focuses on training generative machine learning models using monitored user actions within content presentation applications. The system can continuously monitor user interactions, such as adjustments to image sequences, changes within the images themselves (e.g., such as by using image editing software), scroll patterns, and selection behaviors, to create comprehensive training datasets that capture nuanced user preferences and behavior beyond simple selection data. By training generative models, including large language models, generative adversarial networks, and diffusion models on this behavioral data, the system can generate new images and labels that reflect the learned user preferences. This approach can solve the technical problem of limited training data quality by incorporating real-time user behavior patterns, resulting in more accurate content generation and improved personalization.

Another technical solution addresses the technical challenge of ranking and organizing large volumes of content items according to individualized preference scores. A system can extract content items from data repositories, analyze the attributes of the content items, and use machine learning models to generate user configuration scores for each item based on a user's established preferences. By ranking content according to these scores and presenting the items in preference-based order, the system can resolve the technical problem of information overload and inefficient content discovery. This method can reduce the computational burden on users by automatically filtering and organizing content, while improving engagement through more relevant content presentation sequences.

Another technical solution focuses on generating personalized user configuration recommendations. A system can create detailed profiles for multiple users that include user configurations and associated attributes, then train generative machine learning models on these profiles to recommend content for new users based on similarity patterns. This approach can resolve the technical problem of generating accurate recommendations for users with diverse backgrounds and preferences through supervised and unsupervised learning techniques to identify patterns across user populations. The system can facilitate efficient scaling of personalized recommendations by identifying user subsets with similar preferences and applying learned patterns to generate content suggestions for new users.

Another technical solution addresses the challenge of extracting user configurations from natural language input through speech processing and keyword analysis. The system can receive audio utterances from users, apply natural language processing models to extract relevant keywords, and use machine learning algorithms trained on keyword-preference mappings to determine user configurations from the spoken input. In doing so, the system can resolve the technical problem of limited input modalities for preference determination by enabling voice-based preference collection, which can complement visual selection data and provide more comprehensive user preference profiles. The system can implement speaker identification and adaptive weight assignment for keywords, improving the accuracy of preference extraction while reducing the burden on users to manually specify their interests.

One technical problem addressed by the systems and methods described herein is that users navigating digital content repositories face limitations in how content is organized and personalized on user interfaces. With the ever-increasing volume of content, users often struggle to locate the items most relevant to their preferences due to static or generic content arrangement. These conventional methods typically do not consider individual user interactions or preferences, leaving users to manually sift through content or adjust their views. Similar to the challenge of organizing desktop icons based on frequency of use, there is a pressing need for systems that can dynamically arrange and prioritize content items according to personalized user configurations and behaviors, providing immediate access to the most pertinent information.

By implementing the systems and methods described herein, a system can automatically extract, process, and reorder content items on a user interface based on user-specific configurations and preferences. The system can use one or more processors to extract a plurality of content items (e.g., images) from a data repository and then employ a machine learning model to evaluate these items against user configurations and attributes, generating a personalized score for each item. By ranking the content based on these scores, the system determines an optimal arrangement for displaying content items. The system can automatically adjust the positions of the content items. This automation enhances user interaction by providing a tailored content display that reflects individual preferences and usage patterns, improving accessibility and engagement without necessitating manual adjustments.

Collectively, these technical solutions address fundamental limitations in content personalization systems by integrating multiple data sources, implementing advanced machine learning architectures, and creating adaptive feedback mechanisms that improve over time. The disclosed methods solve critical technical problems including sparse training data, inefficient cross-user preference transfer, limited behavioral monitoring capabilities, poor content ranking algorithms, and restricted input modalities for preference determination. Through these integrated approaches, the systems can achieve improved computational efficiency, enhanced personalization accuracy, and more effective content generation and recommendation capabilities compared to conventional approaches that rely on isolated data sources and static recommendation algorithms.

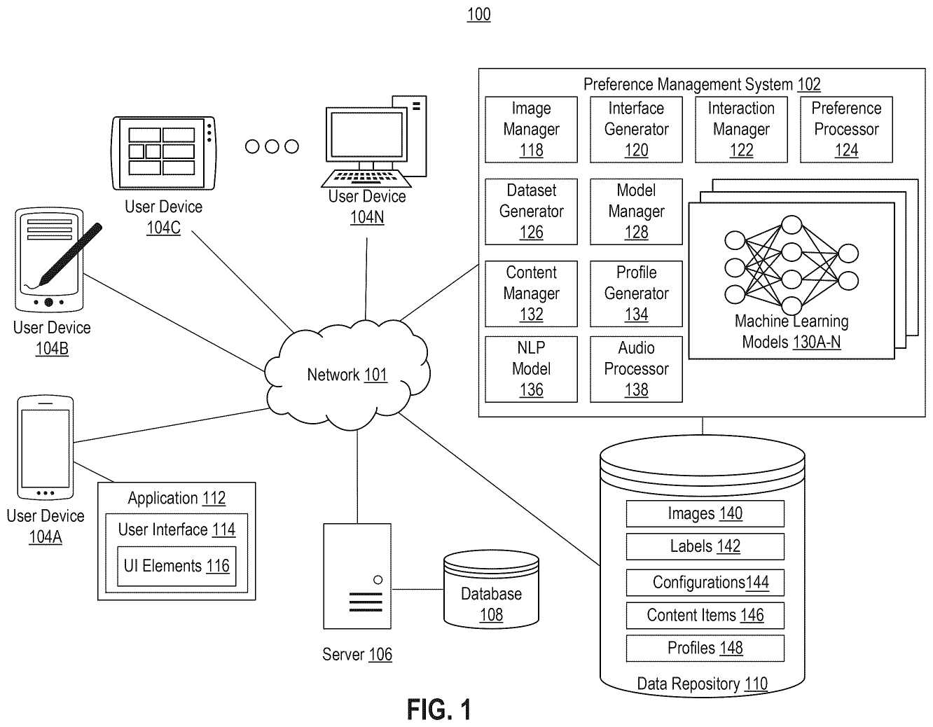

FIG. 1 illustrates components of an artificial intelligence (ML) enabled electronic image and preference generation system 100. The system 100 can include at least one preference management system 102, a plurality of user devices 104A-N (hereinafter generally referred to as user devices 104), at least one server 106, at least one database 108, and at least one data repository 110. The above-mentioned components may be connected to each other through a network 101. The examples of the network 101 may include, but are not limited to, private or public LAN, WLAN, MAN, WAN, and the Internet. The network 101 may include both wired and wireless communications according to one or more standards and/or via one or more transport mediums The communication over the network 101 may be performed in accordance with various communication protocols such as Transmission Control Protocol and Internet Protocol (TCP/IP), User Datagram Protocol (UDP), and IEEE communication protocols. In one example, the network 101 may include wireless communications according to Bluetooth specification sets, or another standard or proprietary wireless communication protocol. In another example, the network 101 may also include communications over a cellular network, including, e.g., a GSM (Global System for Mobile Communications), CDMA (Code Division Multiple Access), EDGE (Enhanced Data for Global Evolution) network.

The user device 104 (sometimes herein referred to as an end user computing device) may be any computing device comprising one or more processors coupled with memory and software and capable of performing the various processes and tasks described herein. The user device 104 may be in communication with the session management service 105 and the data repository 110 via the network 101. The user device 104 may be a smartphone, other mobile phone, tablet computer, wearable computing device (e.g., smart watch, eyeglasses), or laptop computer. The user device 104 may be used to access the application 112. In some embodiments, the application 112 may be downloaded and installed on the user device 104 (e.g., via a digital distribution platform). In some embodiments, the application 112 may be a web application with resources accessible via the network 101.

Each user device 104 can include at least one application 112. The application 112 may include or provide at least one user interface 114 with one or more user interface (UI) elements 116A-N (hereinafter generally referred to as UI elements 116). The user device 104 can use the application 112 to communicate with devices across the network 101, such as the preference management system 102 or other computing systems or computing devices.

The preference management system 102 may be any computing device including one or more processors coupled with memory and software and capable of performing the various processes and tasks described herein. The preference management system 102 may be in communication with the one or more user devices 104, the server 106, and the data repository 110 via the network 101. The preference management system 102 may be situated, located, or otherwise associated with at least one computer system. The computer system may correspond to a data center, a branch office, or a site at which one or more computers corresponding to the preference management system 102 are situated.

The preference management system 102 can include (e.g., as modules or sets of instructions stored in memory of the preference management system 102) at least one image manager 118, at least one interface generator 120, at least one interaction manager 122, at least one preference processor 124, at least one dataset generator 126, at least one model manager 128, machine learning (ML) models 130A-N (hereinafter generally referred to as machine learning models 130), at least one content manager 132, at least one profile generator 134, at least one natural language processing (NLP) model, and/or at least one audio processor 138. The components 118-138 can operate together to provide or provision a platform to user devices through which users can select from sequences of sets of images for automatic content preference determinations and/or automatic content generation.

In one example, the image manager 118 can extract and select images 140 from the data repository 110. The interface generator 120 can generate a respective user interface 114 for a user (e.g., a student or a teacher). The interaction manager 122 can detect interactions by the user with the application 112 or the user interface 114. The preference processor 124 can determine a predicted user configuration 144 for the user based on such detected interactions. A user configuration can be a preference of a user for reading, such as a location in which the user prefers to read, a type of book to read, a time that the user likes to read, etc. The dataset generator 126 can generate datasets for the ML models 130. The model manager 128 can apply the datasets to the ML models 130 for training. In one example, the content manager 132 can extract or retrieve content items 146 from the data repository 110 and/or generate the content items 146 for the students based on information provided by an instructor or teacher. The profile generator 134 can generate profiles 148 for the students. The NLP model 136 can generate keywords from the spoken words from the students. The audio processor 138 can generate audio data from the spoken words of the students.

The architecture for the ML models 130 can include, for example, a deep learning neural network (e.g., convolutional neural model architecture), a regression model (e.g., linear or logistic regression model), a random forest, a support vector machine (SVM), a clustering algorithm (e.g., k-nearest neighbors), or a Naïve Bayesian model, among others. In general, the ML models 130 may have at least one input and one output. The input and output may be related via a set of weights and/or parameters of the respective ML models 130 that are applied to the input to generate the output. In one example, the input can include selections of images from the application 112. The ML models 130 can apply the weights and/or parameters to the selections of images to generate the output. The generated output can include user configurations, images, and/or recommendations of specific content (e.g., books, such as International Standard Book Numbers (ISBNs) of books) for the user that provided the input. The set of weights can be in accordance with the machine learning architecture. The ML models 130 can be trained using a training dataset (e.g., using supervised learning techniques).

The server 106 may be any computing device comprising a processor and non-transitory machine-readable storage capable of executing the various tasks and processes described herein. Non-limiting examples of such computing devices may include workstation computers, laptop computers, server computers, laptop computers, and the like. While the system 100 includes a single server 106, in some configurations, the server 106 may include any number of computing devices operating in a distributed computing environment. The server 106 may be configured to access and extract data from within the database 108.

The database 108 may store and maintain various resources and data associated with the school districts, libraries, geographical location, among others. The database 108 may include a database management system (DBMS) to arrange and organize the data maintained thereon, such as the school districts, libraries, geographical location, among others. The database 108 may be in communication with the server 106. While running various operations the server 106 may access the database 108 to retrieve identified data therefrom.

The data repository 110 may store and maintain various resources and data associated with the preference management system 102, the server 106, and/or the application 112. The data repository 110 may include a database management system (DBMS) to arrange and organize the data maintained thereon, such as the images 140, the labels 142, among others. The data repository 110 may be in communication with the preference management system 102 and the one or more user devices 104 via the network 101. While running various operations, the preference management system 102, the application 112, and the server 106 may access the data repository 110 to retrieve identified data therefrom. The preference management system 102, the application 112, and the server 106 may also write data onto the data repository 110 from running such operations.

The data repository 110 can store a plurality of images 140, a plurality of labels 142 respectively corresponding to each image 140, a plurality of user configurations 144, a plurality of content items 146, and a plurality of profiles 148. Each image 140 can correspond to images 140 extracted from the server 106, generated by the ML model 130, or uploaded by a user (e.g., students, teachers). Each label 142 can define or give context to the image 140 based on geographical location and preferences of the user. The user configurations 144 can be or correspond to the preferences of the users (e.g., students), predicted reading preferences (e.g., predicted user configurations) of the students, and/or expected reading preferences (e.g., expected user configurations) of the students. In some instances, the user configurations 144 can include a set of attributes for the user (e.g., demographic information, preferred reading content, reading background, reading level, among others). The content items 146 can correspond to content for instruction by the teachers. The profiles 148 can correspond to one or more reading preferences of each student.

The system 100 is not confined to the components described herein and may include additional or alternate components, not shown for brevity, which are to be considered within the scope of the embodiments described herein.

### Using AI to Generate Images and Labels for Students

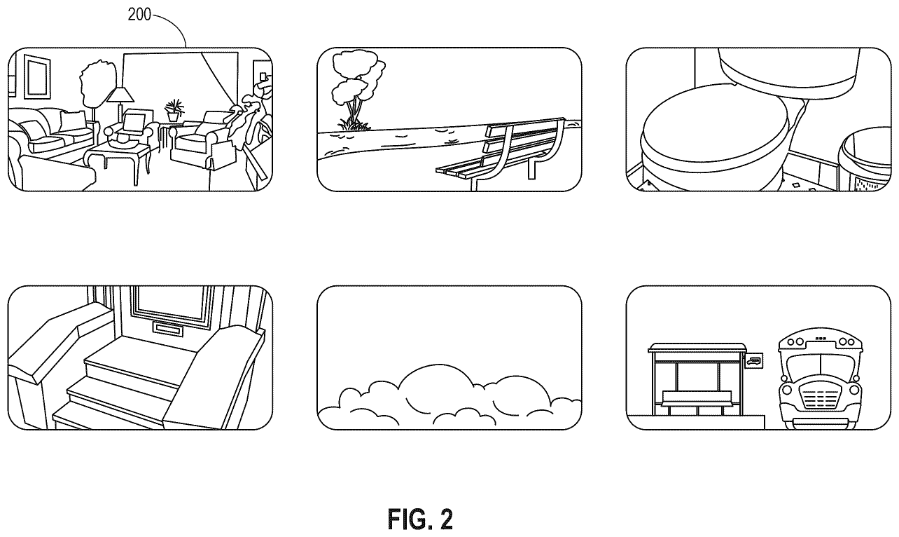

Referring still to FIG. 1, the server 106 can extract images 140 and labels 142 corresponding to the images 140 from the database 108. Each label 142 can indicate content corresponding to the image 140. The content can describe or summarize the image 140 using one or more words, as shown in FIGS. 2-11. The database 108 can house or store a plurality of images 140 and labels 142 from various data sources, such as online web sources, web domains, web servers, libraries, E-books, presentations, instruction plans, among others. The database 108 can include multiple instances of one or more images 140 and labels 142 corresponding to the images 140. For example, the database 108 can include one or more images corresponding to an object labeled “cloud.” In another example, the database 108 can include or more images corresponding to an object labeled “bus stop.”

Prior to extracting the images 140 and labels 142 corresponding to the images 140 from the database 108, the server 106 can provide the database 108 with the plurality of images 140 and labels 142 from the various online web sources, web domains, web servers, libraries, E-books, presentations, instruction plans, among others. In some embodiments, the server 106 can provide, authorize, or allow access to each of the data sources. For example, the server 106 can continuously monitor the various online web sources for content to provide to the database 108. To provide the content to the database 108, the server 106 can include instructions to query to the database 108 for the content extracted from the web source. In some instances, the database 108 can include a cache database that stores recently used or discovered content. In this manner, the server 106 can query the cache database 108 to detect or verify whether the content was previously stored. In this manner, the server 106 can continuously provide the database 108 with images 140 and labels 142 corresponding to the images 140 using fewer computing resources by using the cache database 108.

The server 106 can extract the plurality of images 140 and the labels 142 from the database 108. In some instances, the server 106 can extract each instance of one or more images 140 from the plurality of images 140 within the database 108. FIG. 2 depicts an example 200 of images 140 and labels 142 extracted from the database 108. For example, the server 106 can extract images of a living room with a label of “living room.” In another example, the server 106 can extract images of a park bench with a label of “park bench” from the database 108. In another example, the server 106 can extract images of a bus stop with a label of “bus stop” from the database 108.

Upon extraction from the database 108, the server 106 can transmit the images 140 and the labels 142 to the image manager 118 over the network 101. The image manager 118 can receive each image 140 and label 142 for the students associated with the system 100. Upon reception of the images 140 and the labels 142, the image manager 118 can store the images 140 and the labels 142 in the data repository 110. In this manner, the image manager 118 can generate a data structure to maintain each image 140. The data structure can be at least one of an array, a linked list, a stack, a queue, a binary true, an adjacency matrix, a heap, a Hash Map, a Hash Table, a Hash Set, among others. For example, the data structure can maintain each image 140 in a linked list. In another example, the data structure can be or include a map or mapping (e.g., a hash map or a relational map) where the “key” is a hash or other value mapping to or corresponding to the image 140 and/or a label 142 of the image.

The image manager 118 can generate, form, or otherwise determine a set of images 140. The set of images can include at least one image 140 or any number of images (e.g., predefined number, four images, three images, etc.). To determine the set of images 140, the image manager 118 can assign a weight to each image 140. Each weight can correspond to a likelihood that the student may interact with the image 140. Based on the weights of each image 140, the image manager 18 can select one or more images with the highest weight or one or more images 140 that include a similar weight and assign the one or more images as the set of images 140. For example, an image 140 assigned with a higher weight can indicate that there is a higher likelihood of the student interacting with the image. In some cases, when initially storing the images 140 into the data repository 110, the image manager 118 can assign a null value, a zero, a minimum threshold (e.g., a minimum defined value that a weight for an image may not decrease below), or a low metric for each image 140. Based on selections of the images 140, the image manager 118 can increase the weight of the image (e.g., based on selections of the image) or decrease the value (e.g., based on the image not being selected after being presented), thereby allowing the system 100 to use images 140 that elicit reactions on the user device 104.

In some cases, the image manager 118 can use location information to identify images to include in sets of images. For example, the image manager 118 can identify location information associated with the user device 104. The location information can correspond to at least one of IP-based geolocation, Wi-Fi triangulation, global positioning system (GPS), browser based location services, or tower triangulation, among others. In some cases, the user of the user device 104 can input the location information into the user device 104. The location information can indicate at least one of school district information, state location or the geographical location as described above. The image manager 118 can store identifications of the locations with the images 140 and/or the labels 142 for the images in the data repository 110.

The image manager 118 can use the location information of the user device 104 to select, identify, or extract images (e.g., only select images) that are labeled with the same location or that are labeled with a location within a threshold distance of the location of the user device 104. For example, the image manager 118 can identify a domain of images that correspond to labels that are within a threshold distance of the distance of the user device 104. The image manger 118 can then use the weights of the images in the domain to generate the individual sets of images, as described above. The image manager 118 can select one or more labels to include with each image in the sets of images based on the location of the user device (e.g., an image can correspond to different sets of labels that each correspond to different locations, and the image manager 118 can select the set of labels that corresponds to the location of the user device 104 (e.g., that matches or is the closest to the location of the user device)).

In some cases, the image manager 118 can change, adjust, or otherwise modify the sets of images 140 based on a user (e.g., a user) interacting with the application 112. For example, the user can search, via a web browser (e.g., Safari, Firefox, Internet Explorer) or another application, for specific images 140 or reading content. In response to receiving the search, the image manager 118 can identify and select images that correspond to the search (e.g., based on a relevance of the images to the searched text). For example, the image manager 118 can query the database 108 to identify an image 140 that is similar to the searched image 140. The image manager 118 can compare the image from the database 108 against the image 140 from the search. From here, the image manager 118 can determine that the image from the search satisfies a similarity threshold indicating that the image 140 within the search is within the database 108. The image manager 118 can transmit the selected images to the web browser or application for presentation. The user can view the selected images and select images for inclusion into a set images or, indicate not to include images in a set of images. The image manager 118 can use the selection of images to add or remove images from a set of images 140 that was previously created or to create a new set of images. The image manager 118 can adjust or create any number of sets of images.

In some cases, the image manager 118 can use the user interactions to update the weights assigned to the images. For example, the image manager 118 can update stored weights for interacted images based on the user interactions. The image manager 118 can do so by increasing (e.g., by a defined amount) the weight for images selected for inclusion and/or by decreasing (e.g., by a defined amount) the weight for images indicated not to be included or otherwise not selected for inclusion in a set of images. In updating the weights, the image manager 118 can continuously provide images that include a likelihood of an interaction with the user. In some instances, the weights can correspond to a frequency of occurrence.

In some cases, the image manager 118 can dynamically change a set of images over time. The image manager 118 can do so based on the weights of the images of the set of images and/or the weights of stored images. For example, over time, the image 118 can adjust the weights of the images of the set of images, such as based on user inputs of a user configuring the set of images and/or based on the user inputs selecting individual images of the set of images to perform the process described herein. Based on these adjustments, the image manager 118 can detect a weight is below a threshold. Responsive to the detection, the image manager 118 can identify an image from the database 108 with a weight that exceeds the threshold or a different threshold. The image manager 118 can replace the image in the set of images with the identified image from the database 108.

The image manager 118 can generate a sequence of sets of images from the images 140. Each set of images can include a number (e.g., a defined number, such as three) of images. The sequence can include a first set of images, a second set of images, a third set of images, and so on. The image 118 can generate the sequence based on a user input or otherwise pseudo-randomly select the sets of images to include in the sequence of images. The image manager 118 can access the data repository to retrieve or extract a list of identifiers that correspond to each image (e.g., filenames, path, keys, database table). Upon retrieval of the list of identifiers, the image manager 118 can generate a random number or value that corresponds to a row or column of the available images within the data repository. Using the random number value, the image manager 118 can obtain the image data at the location within the data repository that corresponds to the identifier.

In some cases, the image manager 118 can organize each set of images using the weight assigned to each image in the respective sets of images. For instance, the image manager 118 can organize the sets of images such as the sets with the higher weights are presented earlier. To do so, the image manager 118 can use a summation formula to add each weight assigned to each image in the set of images to obtain a total weight for the set of images. Comparing each total weight assigned to each respective set of images, the image manager 118 can organize the respective sets of images. For example, the first set of images can include a first total weight, the second set of images can include a second total weight that is greater than the first total weight, and the third set of images can include a third total weight that is less than the first total weight and the second total weight. From here, the image manager 118 can organize the sequence such that the order is the second set of images, the first set of images, and then the third set of images.

The interface generator 120 can provide instructions to the application 112 to generate or render the user interface 114. The instructions can include an executable binary that causes the client device 104 to generate the user interface 114. The instructions can include the sequence of sets of images to be rendered on the user interface 114 The user interface 114 can be configured to present a plurality of sets of images 140 in sequence (e.g., one after the other), receiving a selection from each set of images of the sequence during the presentation. The user interface 114 can be configured to receive interactions indicating the selection of the image 140 from the sequence of sets of images 140 using the UI elements 116.

The UI elements 116 can be embedded within the images 140 or the labels 142 corresponding to the images 140. For example, the UI elements 116 can include one or more actionable objects configured to receive, detect, or otherwise obtain interactions (e.g., button click, image selection) from the user. The actionable objects can be embedded within the images 140 or the labels 142 rendered by the user interface 114.

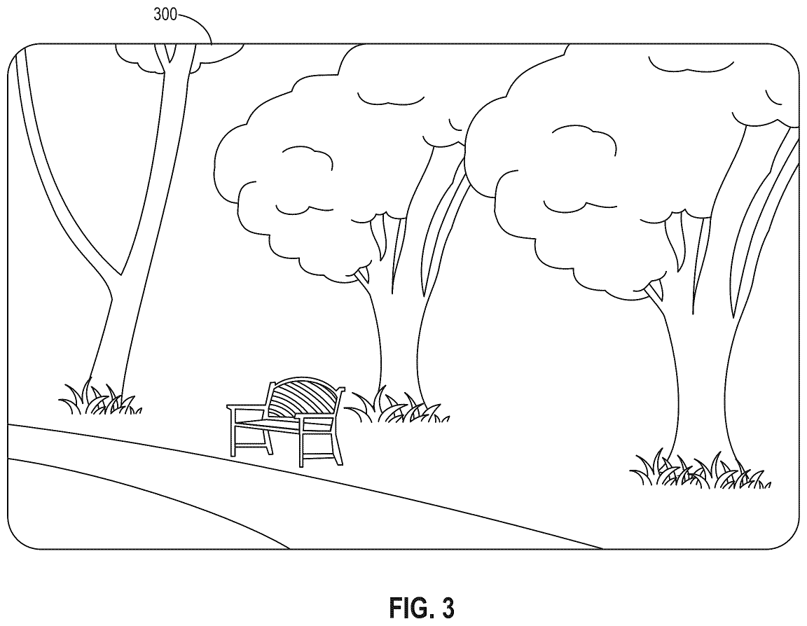

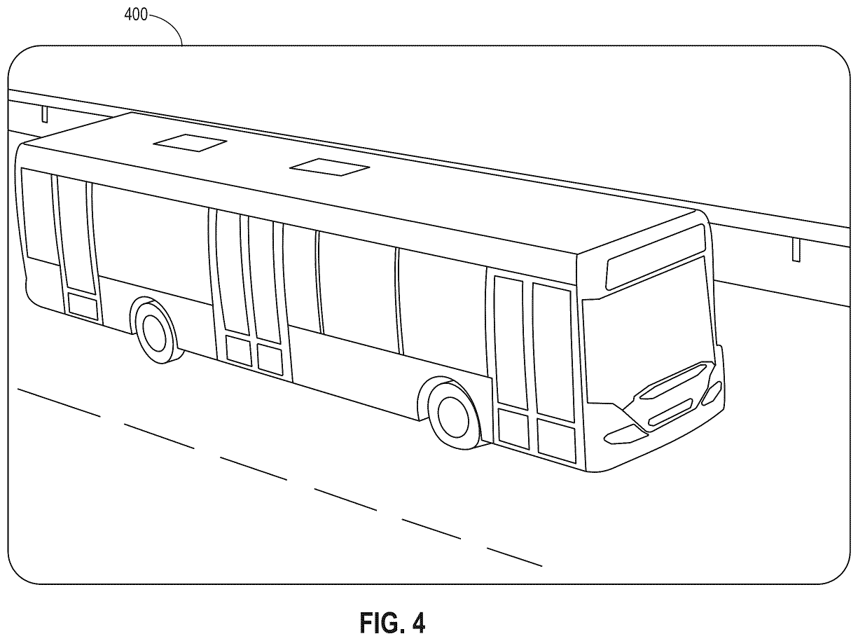

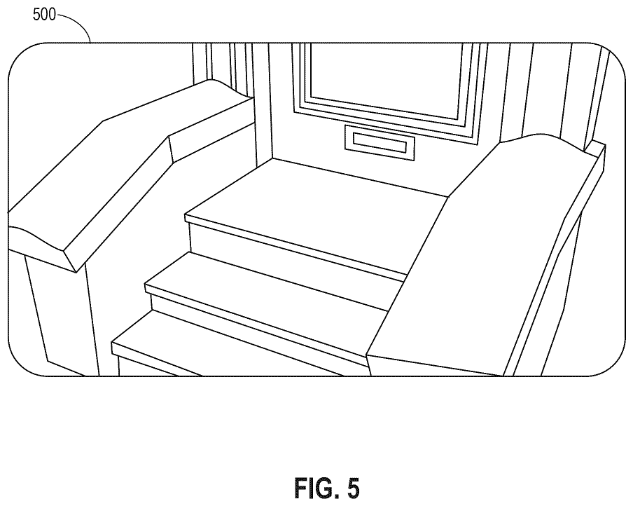

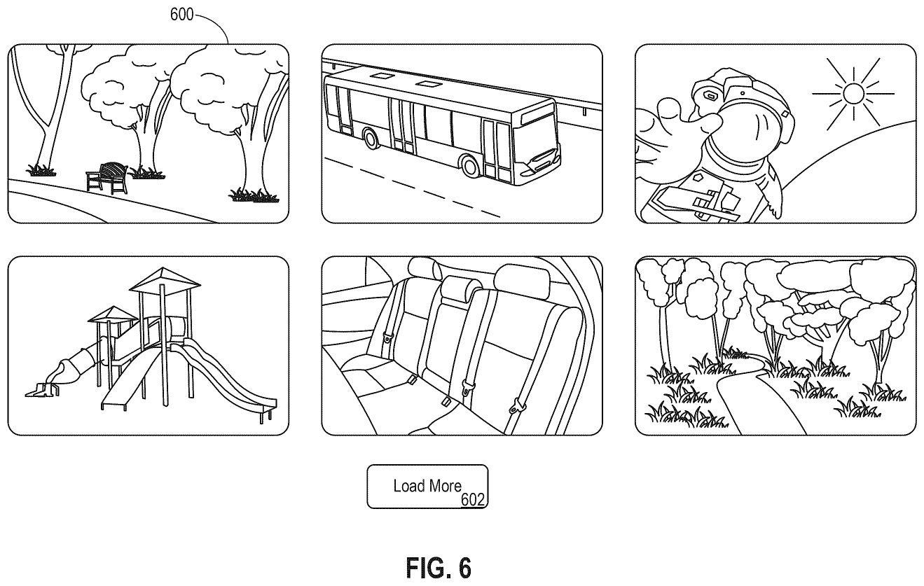

The interface generator 120 can present (e.g., in the order determined as described herein) the sequence of sets images 140 to the user interface 114 of the user device 104. To present the sequence of sets of images 140, the interface generator 120 can transmit instructions to the user device 104 or the application 112 executing on the user device 104. The instructions can include computer readable code that causes the UI elements 116 of the user interface 114 to generate, render, or otherwise present each image 140 or set of images in the sequence of sets of images 140. For example, the instructions can cause the UI elements 116 to present an image 300 of a “park,” as shown in FIG. 3. In another example, the instructions can cause the UI elements 116 to present an image 400 of a “public bus,” as shown in FIG. 4. In another example, the instructions can cause the UI elements 116 to present an image 500 of “stairs,” as shown in FIG. 5. In another example, the instructions can cause the UI elements to generate a plurality of images 600 as shown in FIG. 6. The user interface 114 can include a button 602 (e.g., actionable object). The user interface 114 can receive an interaction with the button 602. Upon a selection of the button 602, the interface generator 120 can access, extract, or otherwise identify an additional set of images 140. The interface generator 120 can replace, modify, or otherwise change the images 600 to the additional images. The interface generator 120 can transmit the new images to the user device 104. The user device 104 can present the new images at the user interface. The interface generator 120 can repeat this process for a defined sequence of images to receive a selection of an image from each set of images of the sequence of sets of images 140.

In one example, the interaction manager 122 can receive a selection of an image 140 from each set of images 140 at the user device 104. The selection can correspond to one or more user actions detected by the application 112 executing on the user device 104. The one or more user actions can correspond to a tap, a double tap, a swipe, a long press, a pinch, a button press, a text input, a gesture, among others. For example, the student can press the image 140 presented by the UI elements 116 to select the image. Upon selection of the image 140, the interaction manager 122 can increase the weight assigned to the image 140 to indicate that the student prefers to read in the environment specified by the image 140. For example, the student can select an image 140 of a “park,” signifying that the student prefers to read in a park.

The preference processor 124 can determine a predicted user configuration for a student using the user device 104 based on the selections of the images 140. The predicted user configuration can correspond to the content of the image 140 associated with the label 142. The preference processor 124 can determine the predicted user configuration using a machine learning model (e.g., a neural network, a deep learning model, a random forest, a support vector machine, etc.). For example, the preference processor 124 can input each of the selections of the images (e.g., vectors representing features of the respective images) and/or the labels for the selected images into a machine learning model trained or configured to generate user configurations (e.g., reading preferences) for users based on such selections. The preference processor 124 can execute the machine learning model based on the input to cause the machine learning model to generate or output a user configuration for the user.

For instance, the preference processor 124 can use similarities between the images to determine a reading preference for a user. The similarities can correspond or refer to a context associated with the image, a cluster of pixels within the image, a theme of the image, among others. The preference processor 124 can execute a machine learning model to extract features from each of the selected images. The preference processor 124 can identify features that are common between the selected images. For example, the student can select a first image of a car, a second image of a train, a third image of a bus, and a fourth image of an airplane. The preference processor 124 can compare the extracted features between the images and identify features that match (e.g., are identical) between all or at least a threshold number of the images. The preference processor 124 can identify “movement,” “traveling,” and “passenger” as the one or more similarities between the images 140 based on those being matching features of the selected images. The preference processor 124 can generate a list of such features. In some cases, the list can be or include user configurations for the user. In some cases, the preference processor 124 can input the list into another machine learning model configured or trained to generate user configurations to generate or output a user configuration for the user.

In some cases, the location information can influence or modify the user configurations of a student using the user device 104. For example, a student located in Maryland can have a different reading preference from a student located in Florida. The preference processor 124 can use an identification of the location of a user as input into the machine learning model with the extracted matching features and/or the images themselves to influence the output user configuration for the user.

In some cases, the preference management system 102 can train a generative machine learning model to generate images that are more likely to generate user configurations for users. The preference management system 102 can do so using real-time selections from users. For example, the dataset generator 126 can create a training set that includes a plurality of examples of inputs and outputs. An example can include inputs that correspond to the selections of images 140, the labels 142 corresponding to the images 140, and the predicted user configuration for the student determined as described above. The output can correspond to an expected user configuration based on the student. The expected user configuration can also be included in the example. The expected user configuration can be the actual reading preference for the student. In some cases, the data set generator 126 can compare the predicted user configuration with the expected configuration to determine whether they match, are within a threshold similarity with each other, or otherwise do not match. The dataset generator 126 can include the output of the comparison in the example in the dataset. The data set generator 126 can include any number of such examples. The dataset generator 126 can create the training set generated from one or more examples for each student associated with the system 100 and store training set in the data repository 110. In some cases, the training set can further include the location information of the user devices 104 accessing the application 112.

The model manager 128 can train the at least one ML model 130 (e.g., neural network or a generative machine learning model configured to automatically generate images according to an input prompt or instructions) to generate images 140 and labels 142 corresponding to the images 140 by applying the training set to the at least one ML model 130. In operation, the model manager 128 can feed the ML model 130 the individual examples (e.g., each including the selection of images 140, labels of the selected images, location information, the predicted user configuration, the expected user configuration, and/or the output of the comparison between the predicted and expected user configuration) of the training set. Each layer of the ML model 130 (e.g., the encoder, the decoder, the discriminator, and/or the tokenizer) can break up the inputs into feature vectors to process the selections of images 140, the labels 142 corresponding to the images 140, the predicted user configuration for the student, the expected user configuration, and/or the output of the comparison of the predicted user configuration and the expected user configuration.

The model manager 128 can adjust one or more parameters of the ML model 130 based on the inputs such that the ML model 130 would be more likely to generate images and/or labels for the images that are more likely to incur generation or determination of the expected user configuration. To do so, the model manager 128 can adjust the weights and/or parameters based on or proportional to the difference between the predicted user configuration and the expected user configuration. For instance, for examples in which there is a large difference, the model manager 128 can make larger changes or adjustments to the weights or parameters to make the ML model 130 less likely to generate images similar to the selected images. For examples in which there is a small difference or the predicted and expected user configurations match, the model manager 128 can adjust the weights and/or parameters of the ML model 130 to make it more likely that the ML model 130 will generate images and/or labels for the images that are the same as or match the selections of images and/or labels for the selections of images. By adjusting the one or more parameters of the ML model 130, the model manager 128 can update or tune the ML model 130. At each iteration of training, the model manager 128 can tune or update the ML model 130 until the satisfaction of a performance threshold or convergence of the ML model 130.

The model manager 128 can change the weights and/or parameters by a magnitude proportional to a size of the difference. In doing so, the model manager 128 can use a baseline. For example, the model manager 128 can compare a difference between the expected and the predicted user configuration to the baseline to determine a training difference. The model manager 128 can determine a negative training difference if the difference is below the baseline and a positive training difference if the difference is above the baseline. The model manager 128 can use the training difference to train the ML model 130 by making the ML model 130 more likely to generate the selection of images with a negative training difference and/or less likely to generate the selection of images with a positive training difference. In doing so, the model manager 128 can make changes or adjustments to the weights and/or parameters of the ML model 128 proportional to the training difference.

The model manager 128 can use location information to train the ML model 130 and/or a plurality of ML models 130. For example, in some cases, the model manager 128 can include identifications of the location information for the users of the respective examples in the input to the ML model 130 for training. Accordingly, the ML model 130 can be trained to generate images for specific locations. In another example, the ML model 130 may train separate ML models 130 based on the location information such that the model manager 128 can train or generate separate machine learning models to generate images for users of specific locations.

In some cases, the model manager 128 can input or feed the selection of images 140 into the ML model 130. The model manager 128 can execute the trained neural network or generative machine learning model to generate a second sequence of sets of images 140. For example, after training the ML model 130 using the training dataset, the model manager 128 can execute the ML model 130 to generate a plurality of images. The model manager 128 can store the generated images in the data repository 110. The model manager 128 can store the plurality of images in the data repository 110 with weights (e.g., null values or zero) as described above.

For example, the second sequence of sets of images 140 can be different from the first sequence of sets of images 140. During generation, the image manager 118 can assign a weight to each image 140 in the sequence of sets of images 140. The weight assigned to each image 140 can represent an ordering for the images 140 in the sequence. For example, a first image assigned with a first weight can be displayed first in the sequence of images, whereas a second image assigned with a second weight can be displayed last in the sequence of sets of images 140. In this manner, the first weight is greater than the second weight.

The model manager 128 can store generated images in accordance with the locations for which the images were generated within the data repository 110. For example, the model manager 128 can generate images using the identifications of locations, such as by using the identifications of the locations as input when inputting a prompt to generate images into the ML model 130 or by using ML models 130 specific to individual locations. The model manager 128 can store the generated images with identifications of the locations used to generate the images. Subsequently, the image manager 118 can use the locations of the images to generate sets of images for users in the locations corresponding the locations.

The interface generator 120 can present or display the second sequence of sets of images 140 on the user interface 114 of a different user device 104. The second sequence of images 140 can be generated based on the user configurations of a previous sequence of sets of images 140 displayed at a different user interface 114. The application 112 can be configured to render the user interface 114 and display the second sequence of sets of images 140. Each user device 104 can access the application 112, therefore the application 112 can include instructions from the interface generator 120 to generate one or more user interfaces 114 for each sequence of sets of images 140.

The UI elements 116 can detect or obtain one or more interactions within the second sequence of sets of images 140. The one or more interactions can be the same or different from the interactions with the previous UI elements 116 within the user interface 114 of the first user device 104. The one or more interactions can correspond to a subsequent selection of the image for each set of sequence of sets of images 140. In this manner, the systems and methods described herein can user interactions of different user devices 104 to generate images 140 for different user devices 104.

The preference processor 124 can determine a predicted user configuration for another user (e.g., student) using the user device 104 based on the selections of the images 140. The predicted user configuration can correspond to the content of the image 140 associated with the label 142. The preference processor 124 can determine the predicted user configuration for another user in the same manner as described above, such as by using one or more machine learning models. Once determined, the preference processor 124 can generate a record that includes the user configurations 144 for each user for which the preference processor 124 determines or generates the user configurations. In some cases, the preference processor 124 can store indications of the determined user configurations in profiles or data structures for the respective users for which the user configurations were determined.

In some cases, the preference processor 124 can collect, gather, or otherwise store each selected image within the data repository. Once stored, the preference processor 124 can execute machine learning model to identify or extract features from each stored image. Each of the features can correspond to a context of the image, a theme of the image, the environment of the image, and the keywords of the image, among others. The image manager 118 can use the features of the images selected by the first user to determine a sequence of images for a second user associated with or otherwise located in the same location or area as the first user. For example, using the features, the image manager 118 can identify images from the data repository 110 that contain or that otherwise have been tagged with the features that were extracted from the images that were selected by the user. The image manager 118 can do so in response to an input to generate a sequence of images for a second user and determining the second user is within the same location as the first user. The image manager 118 can generate the sequence of images using the identified images based on the context of the second user and/or the weights of the images. For example, a first user configuration within a location (e.g., metropolitan area) can include selections of images that includes, tall buildings, a bench with people in the background, a coffee shop, among other images that relate or correspond to a fast paced life within a major city. To determine a user configuration for a subsequent user configuration within the same city, the image manager 118 124 can generate a sequence of images from images that contain the same features as the selected images used to generate the first user configuration. The preference processor 124 can use the sequence of images to determine a user configuration for the second user. In some embodiments, the preference process 124 can apply the same user configuration to the second user as was assigned to the first user responsive to determining the second user is within the same location as the first user.

In some embodiments, the model manager 128 can receive from the user device 104 (e.g., from an administrator) feedback associated with the generated images 140 and labels 142. The feedback can indicate one or more parameters to improve the ML model 130. The one or more parameters can adjust the biases and the weights of the ML model 130 as described above to generate more accurate images in accordance with the selections of one or more users. The feedback can be converted into a loss metric which is applied to the ML model 130. The loss metric can modify or adjust the weights of the ML model 130 to satisfy a performance threshold by tuning the ML model 130 until convergence.

### Using AI to Generate Images and Labels for Students and Teachers

The server 106 can extract images 140 and labels 142 corresponding to the images 140 from the database 108. Each label 142 can indicate content corresponding to the image 140. The content can describe or summarize the image 140 using one or more words, as shown in FIGS. 2-11. The database 108 can house a plurality of images 140 and labels 142 from various online web sources, web domains, web servers, libraries, E-books, presentations, instruction plans, among others. The database 108 can include multiple instances of one or more images 140 and labels 142 corresponding to the images 140. For example, the database 108 can include one or more images corresponding to an object labeled “cloud.” In another example, the database 108 can include or more images corresponding to an object labeled “bus stop.”

Prior to extracting the images 140 and labels 142 corresponding to the images 140 from the database 108, the server 106 can provide the database 108 with the plurality of images 140 and labels 142 from the various online web sources, web domains, web servers, libraries, E-books, presentations, instruction plans, among others, to the database 108. In some embodiments, the server 106 can provide, authorize, or allow access to each of the data sources. Accordingly, the server 106 can continuously provide the database 108 with images 140 and labels 142 corresponding to the images 140.

The server 106 can extract the plurality of images 140 and the labels 142 from the database 108. In some instances, the server 106 can extract each instance of one or more images 140 from the plurality of images 140 within the database 108. FIG. 2 depicts an example 200 of images 140 and labels 142 extracted from the database 108. For example, the server 106 can extract images of a living room with a label of “living room.” In another example, the server 106 can extract images of a park bench with a label of “park bench” from the database 108. In another example, the server 106 can extract images of a bus stop with a label of “bus stop” from the database.

The server 106 can transmit attributes associated with each student and teacher using the one or more user devices 104 to the interaction manager 122. The attributes can be or correspond to demographics, cultural data, geographic location, hobbies, among others. For example, the attributes of a first student can correspond to the student being of Caucasian descent, living in rural south Georgia, and playing soccer. In another example, the attributes of a first student can correspond to the student being of Hispanic descent, living in Montgomery County, Maryland, and primarily speaking Argentinian Spanish. In another example, the attributes of a first teacher can correspond to the teacher growing up in Alaska, holding master's degree, and teaching advanced reading skills. Using the attributes, the interaction manager 122 can identify a sequence of sets of images 140 within the data repository 110. For example, each image 140 within the sequence of sets of images 140 can relate to (e.g., have a stored association with) one or more attributes. For example, a first image 140 for a teacher from Jamaica can relate to the cultural food associated with Jamaica. In another example, a first image for a student that performs magic tricks can relate to playing cards or famous magicians. Such attributes of the images can be stored with the images.

In some cases, the image manager 118 can identify images that correspond with one or more attributes that match or are the same as the attributes of the first student. For example, the image manager 118 can identify the attributes of the first student from a profile of the first student. The image manager 118 can compare the attributes with the attributes of the different images. The image manager 118 can identify any images with at least one or otherwise at least a defined number of matching attributes to the attributes of the first student. The image manager 118 can use the identified images to include in a sequence of sets of images for presentation to the student. In this manner, the preference management system 102 can identify images 140 for the students and teachers using fewer computing resources by avoiding the need to present every image 140 to the students and teachers.

The image manager 118 can generate, form, or otherwise determine sets of images 140 to include in a sequence of sets of images. Each set of images can include at least one image 140. To determine a set of images 140, the image manager 118 can identify the weights of the images 140 that the image manager 118 identified based on the attributes. The image manager 118 can select images (e.g., a defined number of images) with the highest and/or with weights that exceed a threshold. The image manager 118 can include the selected images in the set of images 140. The image manager 118 can similarly generate any number of sets of images for presentation to the user.

The image manager 118 can generate a sequence of sets of images 140. The sequence can include a first set of images 140, a second set of images 140, a third set of images 140, and so on. The image manager 118 can organize each set of images 140 using the weight assigned to each image 140 in the set of images 140. The image manager 118 can use a summation formula to add each weight assigned to each image 140 in the set of images 140 to obtain a total weight for the set of images 140. Comparing each total weight assigned to each respective set of images 140, the image manager 118 can organize the respective sets of images 140. For example, the first set of images 140 can include a first total weight, the second set of images can include a second total weight that is greater than the first total weight, and the third set of images 140 can include a third total weight that is less than the first total weight and the second total weight. From here, the image manager 118 can organize the sequence such that the order is the second set of images 140, the first set of images 140, and the third set of images 140.

In some cases, the image manager 118 can pseudo-randomly generate the sequence of sets of the images by accessing the data repository to retrieve or extract a list of identifiers that correspond to each image (e.g., filenames, path, keys, database table). Upon retrieval of the list of identifiers, the image manager 118 can generate a random number or value that corresponds to a row or column of the available images within the data repository. Using the random number value, the image manager 118 can obtain the image data at the location within the data repository that corresponds to the identifier

The interface generator 120 can present the sequence of sets images 140 to the user interface 114 of the user device 104. To present the sequence of sets of images 140, the interface generator 120 can transmit instructions to the user device 104 or the application 112 executing on the user device 104. The instructions can include computer-readable code that cause the UI elements 116 of the user interface 114 to generate, render, or otherwise present each image 140 in the sequence of sets of images 140. For example, the instructions can cause the UI elements 116 to present an image 140 of a “park,” as shown in FIG. 3. In another example, the instructions can cause the UI elements 116 to present an image 140 of a “public bus,” as shown in FIG. 4. In another example, the instructions can cause the UI elements 116 to present an image 140 of “stairs,” as shown in FIG. 5. In another example, the instructions can cause the UI elements to generate a plurality of images as shown in FIG. 6.

The interaction manager 122 can receive a selection of an image 140 from each set of images 140 at the user device 104. The selection can correspond to one or more user actions detected by the application 112 executing on the user device 104. The one or more user actions can correspond to a tap, a double tap, a swipe, a long press, a pinch, a button press, a text input, a gesture, among others. Upon each detected user action, the interaction manager 122 can receive or obtain an indication or signal of the interaction from the application 112. The indication include the respective user action captured by the application 112. For example, the student can press the image 140 presented by the UI elements 116 that are configured to enable a user to select the image. Upon selection of the image 140, the interaction manager 122 can increase the weight assigned to the image 140 to indicate that the student prefers to read in the environment specified by the image 140. For example, the student can select an image 140 of a “park,” signifying that the student prefers to read in a park.

The dataset generator 126 can create a training set that includes a plurality of examples of inputs and outputs. The inputs can correspond to the selections of images 140, the labels 142 corresponding to the images 140, and the attributes for the student and the teacher. The output can correspond to an expected sequence of sets of images based on the students and the teachers. The expected sequence of sets of images can be the uploaded images of teachers, previously approved sequences of images, among others. The dataset generator 126 can create the training set for each student and teacher associated with the system 100 and store each training set in the data repository 110. In this manner, the system 100 can continuously adapt the at least one ML model 130 to each respective student and teacher using the user devices 104.

The model manager 128 can train the at least one ML model 130 to generate another sequence of sets of images 140 and labels 142 corresponding to the images 140 by applying the training set to the at least one ML model 130. In operation, the model manager 128 can feed the ML model 130 the inputs of the training set. Each layer of the ML model 130 (e.g., the encoder, the decoder, the discriminator, and/or the tokenizer) can break up the inputs into feature vectors to process the selections of images 140, the labels 142 corresponding to the images 140, and/or attributes for the students and teachers. The model manager 128 can execute the ML model 130 to determine or generate another sequence of sets of images 140 that include a higher weight than the previous sequence of sets of images based on the attributes. In this manner, the model manager 128 can use the ML model 130 to generate various sequences of sets of images 140 and label 142 that correspond to each image 140.

As the preference management system 102 receives the selections of images, the image manager 118 can dynamically adjust the weights assigned to the images. For example, the image manager 118 can increase the weights of the selected images and/or decrease the weights of the presented by non-selected images. Accordingly, when the image manager 118 subsequently generates sets of images for presentation to another user (e.g., another user with similar attributes to cause the images to initially be selected for presentation), the image manager 118 can use modified weights to present more contextually appropriate images for the new user. In this manner, the systems and methods described herein can avoid the use of receiving and processing surveys by using features, attributes, and data associated with a first user and applying such features to a subsequent user.

For example, using the modified weights, the image manager 118 can determine a sequence of sets of images 140. The sequence of sets of images 140 can be based on the selection of the image 140 from the first sequence of sets of images 140 at first user device 104 (e.g., because the sequence can be selected using the modified weights from the first sequence of sets of images 140), the attributes of a second user, and the weight assigned to each image 140. For example, a sequence of sets of images 140 for a second user device 104 can be based on the selection of images from the first user device 104. In another example, the sequence of sets of images 140 can be determined in accordance with the modified weights for each image 140 based on user or student interacting with the user device 104. The image manager 118 can select the images and generate the sequence of sets of images of the second sequence of sets of images in the same or a similar manner to the first sequence of sets of images. The second user of the user device can have the same or overlapping attributes to the first user in the profile of the second user such that the image manager 118 can select images based on the weights that were modified from the selections of the first user.

The interface generator 120 can present the second sequence of sets of images 140 to the user interface 114 of the user device 104 (e.g., the same user device or a different user device from the user device at which the first sequence of sets of images 140 were presented). The interface generator 120 can generate a user interface 114 to present the second sequence of sets of images 140. The user interface 114 can include the plurality of UI elements 116 to configure the application 112 to receive selections and interactions with the second sequence of sets of images 140. To present the second sequence of sets of images 140, the interface generator 120 can transmit second instructions to the user device 104 or the application 112 executing on the user device 104 to cause the UI elements 116 of the user interface 114 to generate, render, or otherwise present each image 140 in the second sequence of sets of images 140. In this way, the preference manager system 102 intelligently adjust which images to present in sequence to account for changes in preferences and do so on a user-by-user basis.

### Using AI to Determine Images and Labels for Teachers as a Default for Instruction

The server 106 can extract images 140 and labels 142 corresponding to the images 140 from the database 108. Each label 142 can indicate content corresponding to the image 140. The content can describe or summarize the image 140 using one or more words, as shown in FIGS. 2-11. The database 108 can house a plurality of images 140 and labels 142 from various online web sources, web domains, web servers, libraries, E-books, presentations, instruction plans, among others. The database 108 can include multiple instances of one or more images 140 and labels 142 corresponding to the images 140. For example, the database 108 can include one or more images corresponding to an object labeled “cloud.” In another example, the database 108 can include or more images corresponding to an object labeled “bus stop.”

Prior to extracting the images 140 and labels 142 corresponding to the images 140 from the database 108, the server 106 can provide the database 108 with or collect the plurality of images 140 and labels 142 from the various online web sources, web domains, web servers, libraries, E-books, presentations, instruction plans, among others, to the database 108. In some embodiments, the server 106 can provide, authorize, or allow access to each of the data sources. In this manner, the server 106 can continuously provide the database 108 with images 140 and labels 142 corresponding to the images 140.

The server 106 can extract the plurality of images 140 and the labels 142 from the database 108. In some instances, the server 106 can extract each instance of one or more images 140 from the plurality of images 140 within the database 108. FIG. 2 depicts an example 200 of images 140 and labels 142 extracted from the database 108. For example, the server 106 can extract images of a living room with a label of “living room.” In another example, the server 106 can extract images of a park bench with a label of “park bench” from the database 108. In another example, the server 106 can extract images of a bus stop with a label of “bus stop” from the database.

Upon extraction from the database 108, the server 106 can transmit the images 140 and the labels 142 to the image manager 118 over the network 101. The image manager 118 can receive each image 140 and label 142 for the teachers associated with the system 100. Upon reception of the images 140 and the labels 142, the image manager 118 can store the images 140 and the labels 142 in the data repository 110. In this manner, the image manager 118 can generate a data structure to maintain each image 140. The data structure can be at least one of an array, a linked list, a stack, a queue, a binary true, an adjacency matrix, a heap, a Hash Map, a Hash Table, a Hash Set, among others. For example, the data structure to maintain each image 140 can be a linked list. In another example, the data structure can be a Hash Map where the “key” corresponds to the image 140 and the “value” corresponds to the label 142.

The image manager 118 can generate, form, or otherwise determine a set of images 140. The set of images can include at least one image 140. To determine the set of images 140, the image manager 118 can assign a weight to each image 140. Each weight can correspond to a likelihood of the student interacting with the image 140. For example, an image 140 assigned with a higher weight can indicate that there is a higher likelihood of the student interacting with the image. When storing the images 140 into the data repository 110, the image manager 118 can assign a null value, a minimum threshold, or a low metric for each image 140. Based on selections of the images 140, the image manager 118 can increase the weight of the image, thereby allowing the system 100 to use images 140 that warrant reactions on the user device 104.

The image manager 118 can generate a sequence of sets of images 140. The sequence can include a first set of images 140, a second set of images 140, a third set of images 140, and so on. The image manager 118 can organize each set of images 140 using the weight assigned to each image 140 in the set of images 140. The image manager 118 can use a summation formula to add each weight assigned to each image 140 in the set of images 140 to obtain a total weight for the set of images 140. Comparing each total weight assigned to each respective set of images 140, the image manager 118 can organize the respective sets of images 140. For example, the first set of images 140 can include a first total weight, the second set of images can include a second total weight that is greater than the first total weight, and the third set of images 140 can include a third total weight that is less than the first total weight and the second total weight. From here, the image manager 118 can organize the sequence such that the order is the second set of images 140, the first set of images 140, and the third set of images 140.

The interface generator 120 can present the sequence of sets images 140 to the user interface 114 of the user device 104. To present the sequence of sets of images 140, the interface generator 120 can transmit instructions to the user device 104 or the application 112 executing on the user device 104. The instructions can include computer readable code that cause the UI elements 116 of the user interface 114 to generate, render, or otherwise present each image 140 in the sequence of sets of images 140. For example, the instructions can cause the UI elements 116 to present an image 140 of a “park,” as shown in FIG. 3. In another example, the instructions can cause the UI elements 116 to present an image 140 of a “public bus,” as shown in FIG. 4. In another example, the instructions can cause the UI elements 116 to present an image 140 of “stairs,” as shown in FIG. 5. In another example, the instructions can cause the UI elements to generate a plurality of images as shown in FIG. 6.

To present the sequence of sets of images 140, the interface generator 120 can generate or execute an application 112 for the user device 104. The application 112 can include the user interface 114 that includes the UI elements 116. The application 112 can cause the teachers to access a remote session in accordance with instruction for one or more students. Using the UI elements 116, the interaction manager 122 can monitor one or more actions performed by the teacher on the user device 104. The interaction manager 122 can detect an interaction with the application 112 that indicates one or more of the actions. The one or more actions can correspond to one or more adjustments to the sequence of sets of images. The one or more adjustments can include additions of images 140, changing of labels 142, removals of images 140, among others. For example, when presented with a sequence of sets of images 140, the teacher can remove at least one image 140 in the sequence of sets of images 140 presented on the application 112. In another example, when presented with a sequence of sets of images 140, the teacher can add at least one image 140 in the sequence of sets of images 140 presented on the application 112 of the user device 104. In another example, when presented with a sequence of sets of images 140, the teacher can change the label 142 of at least one image in a sequence of sets of images 140 presented on the application 112. In another example of an adjustment, the teacher can change different aspects of the images, such as the content of the images (e.g., change colors from one color to another color, change an animal from one animal to another animal, change the type of material from one material to another material, etc.).

The interaction manager 122 or the preference processor 124 can store the adjustments in the data repository 110. The interaction manager 122 can store adjustment data that corresponds to attributes of the teacher. For example, the teacher within a certain age group may adjust the label 142 of “bathroom” to “powder room.” Accordingly, the adjustment data may associate the label 142 of “powder room” to the images 140 used by teachers within the certain age group. Therefore, another teacher of the same age group can be presented with the image 140 and the label “powder room.”

The model manager 128 can execute a generative ML model 130 to generate images and labels indicating content of the generated images corresponding to the generated labels. Using the stored adjustment data within the user configurations 144, the model manager 128 can train the generative ML model 130 to generate images 140 in accordance with the user configurations 144. For example, the model manager 128 can feed the generative ML model 130 a plurality of images 140 and labels 142 associated with a teacher located in Maryland. From here, the one or more layers of the generative ML model 130 can extract a plurality of associations between the images 140 and labels 142 in accordance with information provided by the server 106 associated with Maryland. The information can include color schemes, culture, sports teams, colleges, slogans, among others. The generative ML model 130 can generate or output images 140 and labels 142 in accordance with Maryland. The interface generator 120 can generate a user interface 114 for display within the application 112. The interface generator 120 can generate the user interface 114 in accordance with the actions of a respective user interacting with the user device 104. For example, a first user interface 114 within the application 112 can be generated in accordance with the actions of the first student. By training the ML model 130 in this way, the model manager 128 can train the ML model 130 to simulate the preferences of users with specific attributes (e.g., located in the same area). The model manager 128 can train different models in this way for different attributes such that each model can be trained to generate images that have been tailored to the preferences of the specific attributes (e.g., train a model based on actions by one or more users in Texas, train a different model based on actions by one or more users in California, train a different models based on actions of users of a specific age range, train a different model based on actions by users with specific hobbies (e.g., input identified hobbies), etc.).

In some instances, an administrator (e.g., teacher) can interact with the application 112 to provide information associated with a lesson plan or teaching instructions. The administrator can interact with the user device 104. The interaction manager 122 can receive the information upon detection of one or more interactions with the application 112. The information can include a subject associated with a class, one or more modules for the subject, cultural information of the class, the grade level, among other information associated with the administrator. The model manager 128 can further apply the information associated with the administrator as an input to the ML model 130 to generate images 140 and labels 142 for presentation on a user device 104 that corresponds to the input information.

Upon generation of the images 140 and the labels 142, the interface generator 120 can present the generated images 140 and labels 142 on the user interface 114 of a user device 104 associated with the student. To present the sequence of sets of images 140, the interface generator 120 can transmit instructions to the user device 104 or the application 112 executing on the user device 104 to cause the UI elements 116 of the user interface 114 to generate, render, or otherwise present each image 140 in the second sequence of sets of images 140. In some examples, the administrator can interact with the user device 104 to reject or approve of the images 140 presented to the user interface 114. The rejection can correspond to images that are deemed inappropriate, inaccurate, or irrelevant to the student. In some instances, the administrator can reject or approve of the information of the lesson plan in a similar manner. The model manager 128 can identify such actions and train or retrain the models that generated the respective images according to the actions (e.g., make the model more likely to generate approved images and less likely to generate rejected images). In this manner, the system 100 can generate images 140 and labels 142 that are familiar to students without analyzing each student in the classroom. Therefore, the system 100 can save significant computing resources on one or more computing devices.

### Using AI to Analyze Items in a Content Repository to Arrange Identifications of Content Items on a User Interface

The content manager 132 can extract content items 146 from the data repository 110. The content items 146 can correspond to a book, a catalogue, a magazine, a comic strip, an image (e.g., an image of a sequence of images, as described herein) and the like, that students can read during a time period. Each content item 146 can correspond to a set of attributes describing content associated with the content item 146. The set of attributes can correspond to the genre, the length, the author, the cover design, the format, the theme, among others. For example, a first content item 146 can correspond to a fiction novel. In another example, a second content item 146 can correspond to an autobiography. In another example, a third content item 146 can correspond to superhero comic book.

The interface generator 120 can generate or create at least one user interface 114 for display within the application 112. The user interface 114 can include a plurality of UI elements 116 that are configured to display each of the plurality of content items 146. The generation of the at least one user interface 114 can be in accordance with the one or more attributes or user configurations of the user (e.g., student). For example, the user configurations of a student can indicate that the student prefers to read in an “extraterrestrial environment.” Therefore, the user interface 114 can correspond to or be defined by the user configuration. The UI elements 116 can include a spaceship, meteors, moons, planets, stars, among other aspects relating to outer space. The interaction manager 122 can modify or adjust the user interface 114 based on the set of user configurations for a student.

The interface generator 120 can adjust, modify, or otherwise change the one or more UI elements 116 of a user interface 114. By adjusting the one or more UI elements 116, the interface generator 120 can modify arrangements of content items 146, images 140, and labels 142 presented on the user interface 114. In this manner, the interface generator 120 can arrange content items to indicate a favorable probability of interaction with the user. For example, the interface generator 120 can provide a superhero comic book in the center of the user interface 114, thereby warranting an interaction with the superhero comic and provide a historic novel in a corner of the user interface 114. In some instances, the interface generator 120 can provide the content items in an organized list such that a fiction book is arranged first in the list whereas a non-fiction book is arranged last in the list. Using each content item extracted from the data repository 110, the interface generator 120 can generate or determine an arrangement of identifications of the plurality of content items on the user interface 114 at the user device 104. The first arrangement of content items can be randomized as the user has not indicated any preferences for each of the content items. For example, the interface generator 120 can execute a randomization function to arrange each of the extracted content items. In some examples, the interface generator 120 can generate the arrangement based on the order in which each content item was extracted from the data repository 110.

Concurrently, the image manager 118 can obtain or collect a plurality of images 140 and descriptions from a plurality of data sources (e.g., server 106). The description can include information or data associated with the respective image 140. The description can differ from the label 142. For example, the description can have one or more aspects of the image 140 such as an environment of the image, the time for the image 140, the colors of the image 140, the textures of the image 140, among other aspects of the image 140. Each of the one or more aspects of the image 140 can correspond to the content associated with the images. By breaking down the content, the image manager 118 can indicate a set of attributes for each of the plurality of users.

The image manager 118 can store the plurality of images 140 and descriptions within the data repository 110. The image manager 118 can store the plurality of images 140 in one or more data structures (e.g., array, linked list, data table, Hash, tree, among other data structures). The stored images can include an identifier to signify a location or a path within the one or more data structures. For example, the ID can represent a row and column within an abstract data table. In another example, the ID can represent a respective node within a linked list.

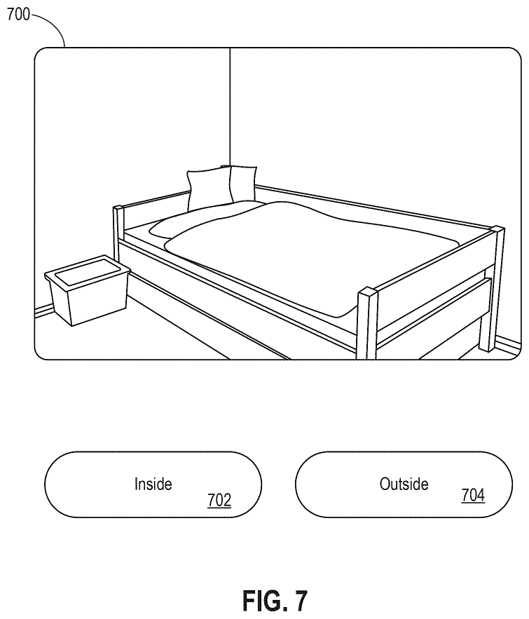

The interaction manager 122 can receive user configurations from the user device 104 of the student. The student may complete a survey on the user device 104 indicating the user configurations. The survey can include generated images 140 and labels 142 with one or more actionable objects for selection by the student. FIGS. 6-11 illustrate examples of the user interface showing the generated images 140, the labels 142 for the generated images, and selections for the images 140. For example, the student can observe an image 700 labeled “bed” as shown in FIG. 7, and select the actionable object. Upon selection of the actionable object, the user device 104 can transmit a user configuration to the interaction manager 122. The student at the user device 104 can select a plurality of actionable objects corresponding to each image 140 to generate the set of user configurations for the interaction manager 122. The interaction manager 122 can store each selection in the database 108 for a respective student. Using the selections, the interaction manager 122 can use a neural network, a linked list, or tree that shows a mappings and connections between each selection of user configurations to generate a reading score for one or more categories of interest. For example, a first score can map to soft surfaces for reading, a second score can make to outdoor reading, and a third score can map to moving modes of transportation for reading. From here, the interaction manager 122 can identify the category of interest with the highest reading score and provide the set of user configurations based on the category of interest.

The model manager 128 can execute a ML model 130 using the user configurations, the content items 146, and the attributes associated with each content item 146 to generate a user configuration score for each plurality of content items 146. The user configuration score indicates a likelihood that the student will interact with the content item 146. For example, a higher user configuration score can indicate a high likelihood that the student will interact with the content item 146. Conversely, a lower user configuration score can indicate a low likelihood that the student will interact with the content item 146.

The model manager 128 can feed the ML model 130 the content items 146, the attributes associated with the content items 146, and the user configuration of the respective student. The one or more layers of the ML model 130 can generate a plurality of expected content items 146 that match the user configurations of the student. For example, if the student prefers to read outside, the ML model 130 can generate nature books for the student. In another example, if the student prefers to read in a room filled with superheroes, the ML model 130 can generate comic books for the student. From here, the ML model 130 can compare each content item 146 against the plurality of expected content items 146 for the respective student. At each iteration of the comparison, the ML model 130 can generate the user configuration score according to a delta between the content items 146 in the data repository 110 and the expected content items 146. In this manner, a smaller delta can indicate high accuracy between the content items 146 of the data repository and the expected content items 146. Conversely, a lower delta can indicate low accuracy between the content items 146 of the data repository and the expected content items 146.

Upon generation of each user configuration score for the plurality of content items 146, the preference processor 124 can rank the content items 146 according to the user configurations scores generated by the ML model 130. The preference processor 124 can assign an indicator to each content item 146 that corresponds to the rank of the content item 146. The indicator can be a metric, a value, or a flag based on the user configuration (e.g., reading preference). For example, a content item 146 can include a high user configuration score, therefore the preference processor can assign an indicator that corresponds to the high reading score. For example, the first content item 146 can include a ranking that is higher than a second content item 146 in the plurality of content items 146. In another example, the first content item 146 can include a ranking that is lower than a second content item 146.

Using the indicators to rank each content item, the preference processor 124 can determine an order for the content items 146 for presentation. The order of the content items 146 can be from the highest rank to the lowest rank. For example, a first content item 146 can include a first user configuration score, a second content item 146 can include a second user configuration score, and a third content item can include a third user configuration score. From here, the preference processor 124 can determine an order of the first content item 146, the third content item 146, and the third content item in accordance with each user configuration score of each content item 146. Upon generation of the order, the interface generator 120 can present identifications of the plurality of content items 146 on a user interface presented on the user device 104 in the order.

The interface generator 120 can determine a subsequent arrangement for the plurality of content items based on the ranking. The subsequent arrangement can be different from the arrangement of the plurality of content items displayed on the user interface. In some cases, the subsequent arrangement can be the same as the arrangement of the plurality of content items displayed on the user interface. The subsequent arrangement can indicate an order to present the identifications of the plurality of content items on the user interface 114. The order can be based on the ranking assigned to each of the plurality of content items. The order can correspond or map to a plurality of positions within the user interface. The plurality of positions can include, for example, a center, proximal to a specific icon, a corner, a leftmost portion, a rightmost portion, on top of a list, a bottom of a list, medial within the list, among ither positions within the user interface 114 of the user device 104.

The interface generator 120 can automatically move, modify, or adjust each of the identifications of the plurality of content items presented on the user interface from a previous arrangement to the subsequent arrangement. The arrangements can be based on or correspond to changes in the position of each content item. For example, a first arrangement can display a superhero comic book as a larger size than an autobiography, and the autobiography as a larger size than a mystery novel. However, based on the rankings, the interface generator 120 can modify the first arrangement to a second arrangement indicating that the mystery novel is a larger size than the superhero comic book which is a larger size than the autobiography. In another example, a first arrangement can include an order of a science fiction book, a fantasy book, and a sorcery book within a list. Based on the ranking, the second arrangement can include a revised order of the fantasy book, the sorcery book, and the science fiction book.

The user interface 114 can provide for display, the order of each content item 146. In some instances, of the order, the first content item 146 can be displayed prior to the second content item 146. In some instances, the first content item 146 can be displayed subsequent to the second content item 146. In some instances, the interface generator 120 can transmit a request to the external server. The request can include an authorization for access to the database (e.g., library) associated with the server to receive an associated description for each content item. An administrator (e.g., teacher) can provide authorization credentials to verify access to the database. The authorization credentials can include an ID, a badge number, a biometric authorization, level of access, username/passwords, application programming interface (API) keys, among others. In response to the authorization credentials verifying the administrator, the external server can provide the content items 146 and a description of each content item 146 to the preference management system 102. However, the server can deny access to the database based on incorrect, unknown, or malicious authentication credentials. In this manner, the systems and methods described herein, can restrict or provide access to external database by using authorization credentials to verify administrators.

### Using Profiles for Students as an Input to AI to Generate Recommendations for User Configurations

The preference processor 124 can extract or obtain the set of user configurations (e.g., reading preferences) from a plurality of users from the data repository 110. The set of user configurations can be stored within answers to a survey, questionnaire, or inputs into the application 112. To extract the set of user configurations, the interaction manager 122 can identify a user accessing the application 112 using one or more authorization credentials. The one or more authorization credentials can include login information, personally identifiable information, user ID, among others. The authorization credentials can be input into the one or more UI elements 116 of the user interface 114.

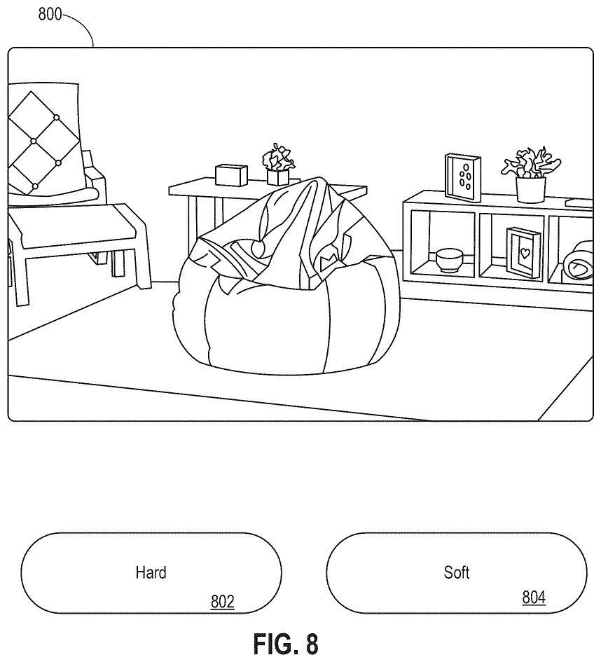

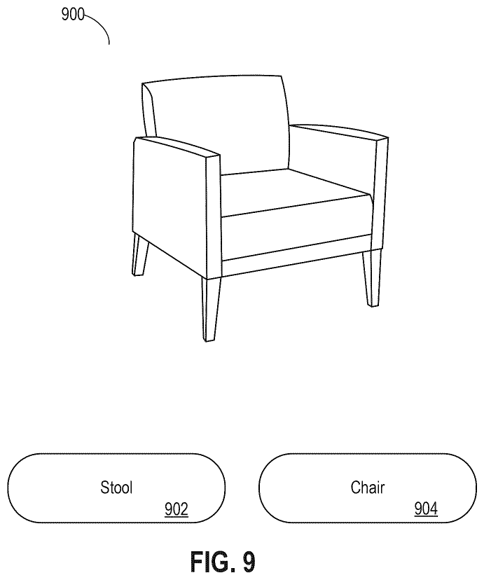

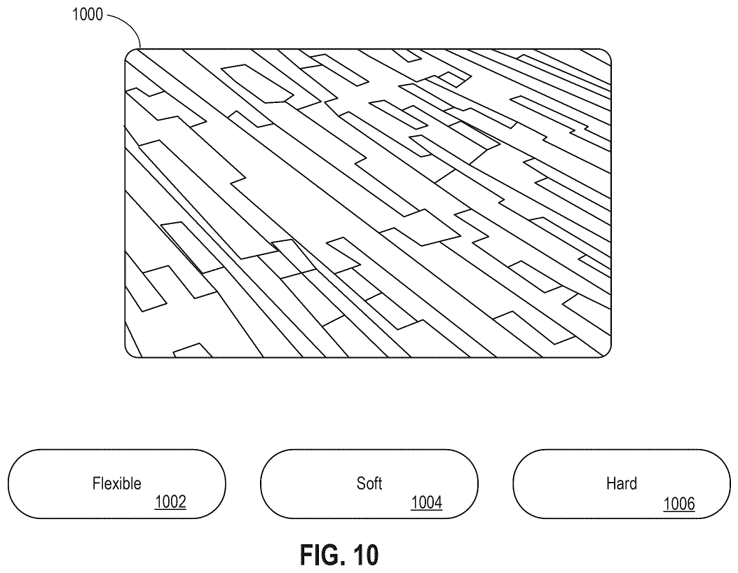

The interaction manager 122 can receive user configurations from the user device 104 of the student. The student may complete a survey on the user device 104 indicating the user configurations. The survey can include generated images 140 and labels 142 with one or more actionable objects for selection by the student. FIGS. 7-10 illustrate examples of the user interface showing the generated images 140, the labels 142 for the generated images, and selections for the images 140. For example, the student can observe an image 700 labeled “bed” as shown in FIG. 7 and select the actionable object corresponding to inside 702 or outside 704. In another example, a student can observe an image 800 labeled “bean bag” as shown in FIG. 8 and select the actionable object corresponding to hard 802 or soft 804. In yet another example, a student can observe an image 900 labeled “chair” as shown in FIG. 9 and select the actionable object corresponding to hard 902 or soft 904. In yet another example, a student can observe an image 1000 labeled “surface” as shown in FIG. 10 and select the actionable object corresponding to flexible 1002, soft 1004, or hard 1006.

Upon selection of the actionable object, the user device 104 can transmit a user configuration to the interaction manager 122. The student at the user device 104 can select a plurality of actionable objects corresponding to each image 140 to generate the set of user configurations for the interaction manager 122. From the survey, the interaction manager 122 can receive a set of attributes associated with the student. The attributes can correspond to information about the respective students. For example, the set of attributes can include demographics, parental occupations, social status, age group, reading level, hobbies, among others, associated with the respective student.

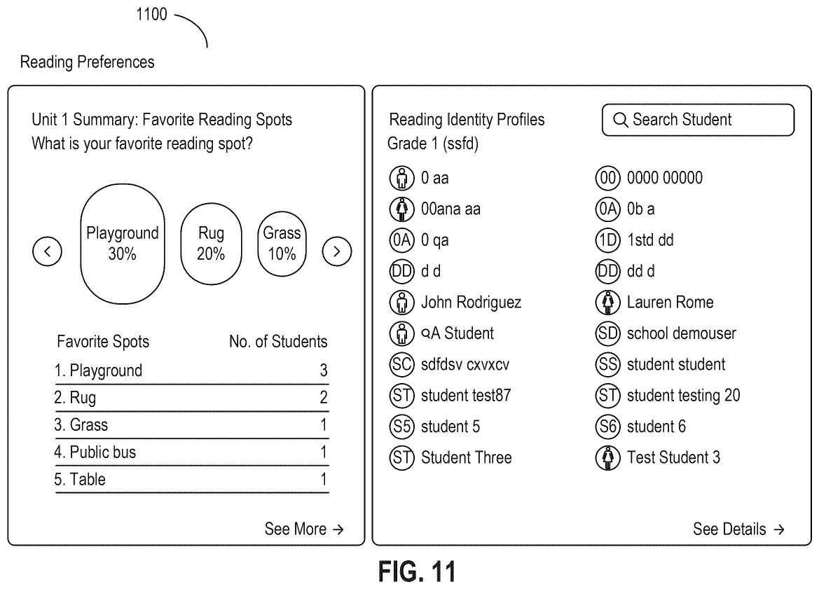

The profile generator 134 can generate profiles 148 for each student that include the user configuration and attributes associated with the students. The profile 148 can be a data structure, such as a dictionary, HashMap, XML, JSON, database table, MongoDB. Using the user configuration and the set of attributes, the profile generator 134 can fill in the one or more fields of the profile 148, as shown in FIG. 11. FIG. 11 illustrates an example of the user interface 1100 showing a dashboard with generated profiles for each student. For example, the fields of the profile 148 can include a name for the student, the demographics of the student, the school district of the student, and the user configurations of the students. In another example, the profile 148 can include parental occupations, ancestor history of the student, and the name for the student. The profiles 148 can include a plurality of fields and the examples described above are simply non-limiting examples. The profile generator 134 can store the profiles 148 of each student in a spatial locality according to similarities between the user configurations and attributes of each of the plurality of users. When profiles 148 of users are in a spatial locality based on the similarities, the profile generator 134 can store an association between each profile within the spatial locality.

The image manager 118 can generate a sequence of sets of images 140 for presentation on a user interface 114 of user device 104 having a different or second profile 148. Each sequence of sets of images can be based on the second profile 148. The second profile 148 can include a second set of attributes which are unique or indicated by a different user (e.g., different student). The sequence can include a first set of images 140, a second set of images 140, a third set of images 140, and so on. The image manager 118 can organize each set of images 140 using the weight assigned to each image 140 in the set of images 140 as described above. The image manager 118 can use a summation formula to add each weight assigned to each image 140 in the set of images 140 to obtain a total weight for the set of images 140. Comparing each total weight assigned to each respective set of images 140, the image manager 118 can organize the respective sets of images 140. For example, the first set of images 140 can include a first total weight, the second set of images can include a second total weight that is greater than the first total weight, and the third set of images 140 can include a third total weight that is less than the first total weight and the second total weight. From here, the image manager 118 can organize the sequence based on the weight (e.g., in ascending or descending order based on the weights) such that the order is the second set of images 140, the first set of images 140, and the third set of images 140.

The interface generator 120 can present the sequence of sets images 140 to the user interface 114 of the user device 104. To present the sequence of sets of images 140, the interface generator 120 can transmit instructions to the user device 104 or the application 112 executing on the user device 104. The instructions can include computer-readable code that cause the UI elements 116 of the user interface 114 to generate, render, or otherwise present each image 140 in the sequence of sets of images 140. For example, the instructions can cause the UI elements 116 to present an image 140 of a “chair.” In another example, the instructions can cause the UI elements 116 to present an image 140 of a “public bus,” as shown in FIG. 4. In another example, the instructions can cause the UI elements 116 to present an image 140 of “stairs,” as shown in FIG. 5. In another example, the instructions can cause the UI elements to generate a plurality of images as shown in FIG. 6.

The interaction manager 122 can receive a selection of an image 140 from each set of images 140 at the user device 104. The selection can correspond to one or more user actions detected by the application 112 executing on the user device 104. The one or more user actions can correspond to a tap, a double tap, a swipe, a long press, a pinch, a button press, a text input, a gesture, among others. For example, the student can press the image 140 presented by the UI elements 116 to select the image. Upon selection of the image 140, the interaction manager 122 can increase the weight assigned to the image 140 to indicate that the student prefers to read in the environment specified by the image 140. For example, the student can select an image 140 of a “park,” signifying that the student prefers to read in a park.

The model manager 128 can train a generative ML model to generate recommendations of content for future students involved with the system 100. The generative ML model can be trained using at least one of supervised or unsupervised learning. To train the generative ML model, the model manager 128 can use the profiles 148 generated by the profile generator 134, user configurations, and identifications of a selection of the image as an input to the generative ML model. The correct recommendations for the students or identifications of content that the student identified as enjoying as can be the ground truth for the training. During training, the generative ML model can generate recommendations for reading content 146 for future students with similar attributes. For example, during a first time, a first enrolled student can have a Jamaican background from St. Ann. Therefore, the profile 148 for the first enrolled student can include attributes associated with St. Ann, Jamaica. From here, the model manager 128 can train the ML model 130 to generate recommendations for reading content 146 (e.g., identifications of recommended reading content) for future students from St. Ann, Jamaica. The model manager 128 can train the ML model 130 until convergence of the one or more parameters.

Upon completion of training, the model manager 128 can execute the generative ML model using a second profile that includes a second set of attributes associated with another student and identifications of the selected images to generate the identification of content for the student. In this manner, the generative ML model 130 can generate identifications of content 146 for users associated with the system 100 and users coming from similar backgrounds not associated with the system 100. Using the generative ML model 130, the system 100 can save a significant amount of computing resources by generating recommendations based on previous interactions with the system. Furthermore, the model manager 128 can adjust and fine tune the parameters of the ML model 130 to generate more accurate recommendations while using fewer computing resources by providing loss metric to the ML model 130 at each iteration of training. The loss metric include the modified weights and parameters based on a deviation between the ground truth recommendations and the recommendations generated by the ML model 130.

In execution of the ML model 130, the model manager 128 can generate the identification of content for a second user based on the profile 148 of a previous user. The model manager 128 can train the ML model 130 based on users with similar user configurations and attributes. The model manager 128 can identify a subset of the plurality of users that include at least one similarity in the set of user configurations by using the association. Each user with similar user configurations and attributes can have a profile within a spatial locality in memory. By using the association between the profiles 148, the system 100 can use portions of memory to train the ML model 130 thereby reducing utilization and saving computing resources by querying a portion of the data repository 110 containing the profiles 148 rather than querying the entire data repository 110. The model manager 128 can execute the ML model 130 to generate the recommendation based on a users' profiles 148 within a spatial locality within the data repository 110. In a similar manner, the model manager 128 can execute the ML model 130 using one or more profiles 148 in spatial locality to generate the identification of content for a subsequent user. The interface generator 120 can generate or revise the user interface 114 to present or include the identifications of content for the user interface 114 of the user device 104 of the student. The user interface can be based on the set of attributes and the user configurations of the user.

### Using Words Spoken by Students to Determine User Configurations

The audio processor 138 can receive an utterance that includes a plurality of words from a user device 104. For example, the student can speak the utterance during a conversation. In another example, the student can speak the utterance during an assessment. The user device 104 can generate audio data of a student speaking into a microphone and transmit the audio data to the audio processor 138. The audio processor 138 can transcribe the utterance according to the audio data. For example, the student can say, “I like to sit outside and watch nature,” into the microphone of the user device 104. The audio processor 138 can detect or identify an individual speaking based on utterances spoken (e.g., into a microphone). The data repository 110 can include audio signals or audio data associated with each plurality of users based on utterances spoken in assessments or conversations. When a student speaks, the audio processor 138 can compare the utterance spoken by the student and audio data of a plurality of students stored within the data repository 110. Based on the comparison satisfying a threshold, the audio processor 138 can identify the individual speaking. From here, the profile generator 134 can store the plurality of words spoken during the utterance into profile 148 identifying the individual.

The model manager 128 can execute the NLP model 136 to extract a plurality of keywords from the utterance. The NLP model 136 can be a Rule-based Model, a Statistical Model, a ML model 130, a Deep Learning Model, among others. To extract the plurality of keywords, the model manager 128 can feed the NLP model 136 the audio data. Upon ingesting the audio data, the NLP model 136 can preprocess the audio data via tokenization, lowercasing, removing stop words, removing special characters, among others. The NLP model 136 can transform the text into numerical text into one or more features, such as bag of words, term frequency-inverse document frequency, word embeddings, sentence embeddings, among others. From here, the NLP model 136 can use speech recognition to covert the utterances into text to extract the plurality of keywords.

The profile generator 134 can generate or identify a profile 148 for each individual speaking or each user using the application 112. The profile 148 can be a data structure, such as a dictionary, HashMap, XML, JSON, database table, MongoDB. Using the user configuration and the set of attributes, the profile generator 134 can fill in the one or more fields of the profile 148, as shown in FIG. 11. The profile generator 134 can populate the profile 148 with the plurality of keywords spoken by the identified user. The profile generator 134 can store the profile 148 in the data repository in a spatial locality to profiles 148 that include similar key words. For example, a first profile 148 can include “trees” as the keyword whereas a second profile 148 can include “forest”. Since “forests” include “trees” the profile generator can store the first profile 148 and the second profile 148 within a spatial locality. The profile generator 134 can assign or indicate a weight to each of the plurality of keywords. The weight can be a metric or value that indicates a frequency of the keywords spoken by the individual. For example, the keyword “tree” can have a weight of 10, whereas the keyword “car” can have a weight of 6. Based on the weights, the profile generator can indicate that the student prefers to read by tree rather than in the car based on the weight.

The model manager 128 can execute a ML model 130 using the extracted plurality of keywords from the utterance to generate one or more user configurations (e.g., reading preferences). The model manager 128 can execute the ML model 130 using the weights for each of the plurality of keywords from the utterance to generate one or more user configurations. Prior to executing the ML model, the model manager 128 can train the ML model 130 using a training set. The dataset generator 126 can generate the training set from a plurality of mappings between keywords and user configurations. For example, the training set can include a mapping between the user configuration associated with being outside and the keyword “nature.” In another example, the training set can include a mapping between the user configuration associated with being in a car and the keyword “riding in a backseat.” The training set can include a plurality of mappings for the ML model 130 to learn to associate the keywords of the utterance and one or more user configurations within the data repository 110. Upon completion of training, the model manager 128 can execute the ML model 130 to generate the one or more user configurations for the student based on the utterances.

The interface generator 120 can present one or more user configurations on the user interface 114 of the user device 104. To present the one or more user configurations, the interface generator 120 can transmit instructions to the user device 104 or the application 112 executing on the user device 104. The instructions can include computer readable code that cause the UI elements 116 of the user interface 114 to generate, render, or otherwise present each user configuration for the respective student. The interface generator 120 can further present mappings between the one or more user configurations and correspond keywords extracted from the utterance. In this manner, the interface generator 120 can receive or detect an interaction indicating an approval or a removal of the keywords to indicate that the keyword is not accurate to the user configuration.

In some instances, the audio processor 138 can receive a subsequent utterance that includes a plurality of words from a user device 104. For example, the student can speak the utterance during a conversation. In another example, the student can speak the utterance during an assessment. The user device 104 can generate audio data of a student speaking into a microphone and transmit the audio data to the audio processor 138. The audio processor 138 can transcribe the utterance according to the audio data. For example, the student can say, “I used to like sitting outside, but now I prefer to stay in my room” into the microphone of the user device 104. The subsequent utterance can contradict or be different from the original utterance. In this manner, the audio processor 138 can modify or adjust the one or more user configurations based on the words spoken by the individual in the subsequent utterance.

### Example Embodiments

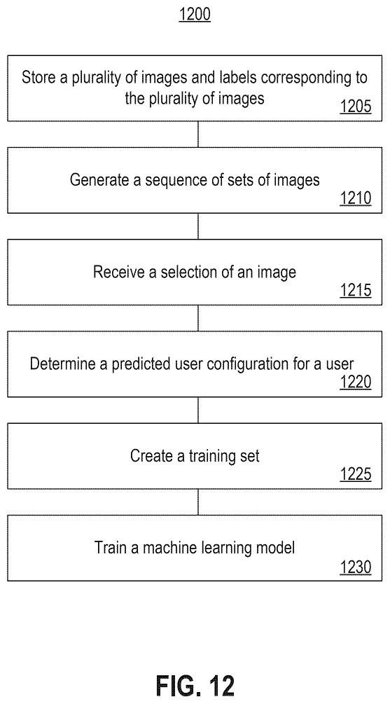

FIG. 12 illustrates a flow diagram of a method 1200 for using ML to generate images and labels for students. The method 1200 can be implemented by any of the various components described in system 100. The method can include storing a plurality of images and labels corresponding to the plurality of images (1205). The plurality of images can include a collection of pixels to represent visual data. The plurality of images can be extracted from a plurality of data sources (e.g., web domains, websites, web browsers, web pages). The plurality of images can be captured by one or more individuals and uploaded to the respective data source or generated by one or more machine learning models (e.g., machine learning model 130). The one or more processors can store each of the plurality of images within a database or data repository. Each of the plurality of labels can map or link to an image of the plurality of images. The label can be a description or prompt to describe or summarize the image. For example, the label for an images of a “park bench” can be “bench.”

The method can include generating a sequence of sets of images for presentation (1210). The sequence of sets of images can include at least a subset of the plurality of images. The sequence of sets of images can be based on one or more attributes associated with a user of a user device. The user can be a student, teacher or administrator controlling or handling the user device. The user device can be at least one of a phone, computer, tablet, among other smart devices compatible with a user interface. The one or more attributes can indicate or define demographic information, reading preferences, ancestry, hobbies, strengths, weaknesses, among other information associated with the user. The one or more processors can identify the one or more attributes based on interactions with the user device. The interactions can correspond to an action at the user interface of the user device. For example, a student can interact with (e.g., provide inputs into) the user device indicating that the student lived in the Caribbean and spent most of their days outside. The Caribbean (e.g., culture, food, weather, environment) can be stored as an attribute for the student. The one or more processors can present a sequence of sets of images in accordance with the environment (e.g., weather and beaches) of the Caribbean. In some instances, the one or more processors can generate a user interface to display the sequence of sets of images.

The method can include receiving a selection of an image (1215). The one or more processors can receive the selection of an image from the sequence of sets of images based on interactions with the user device. The one or more processors can generate or identify a subsequent sequence of sets of images based on the previous selection. The subsequent sequence of sets of images can include the previously selected image and other images similar (e.g., images similar to a couch, images similar to an open field, etc.) to the previously selected image. Each image in the sequence can be extracted from the data repository or generated by a machine learning model. The user device can detect the interaction with one or more graphical user interface elements associated with the image displayed on the user device. Based on the interaction, the one or more processors can register the interaction as the selection of the image.

In one example of performing steps 1210 and 1215, when presenting the sequence of sets of images, the one or more processors can iteratively present different sets of images in order. For example, the one or more processors can present a first set of images at the user device. The first set of images can include a defined number of images. The one or more processors can receive a selection (e.g., a user selection) from the first set of images. Responsive to receiving the selection, the one or more processors can present a second set of images. The one or more processors can receive a selection from the second set of images. Responsive to receiving the selection, the one or more processors can present a third set of images. The one or more processors can repeat this process for each set of images of the sequence. The one or more processors can store an indication of the selected image for each selection.

The method can include determining a predicted user configuration for a user (1220). The predicted user configuration can be an image, a label corresponding to the image, or a summary of an environment for reading. The one or more processors can use the selection of the images and labels corresponding to the images to determine the predicted user configurations. For example, a selection of an image at the beach can determine that the user configurations for the student can include “outside,” “near water,” “soft surfaces,” or “by the beach.” In another example, the one or more processors can display or present three images corresponding to a “couch,” “bean bag,” and “park bench,” respectively. The one or more processors can receive a selection of the “park bench.” Based on the selection, the one or more processors can analyze various aspects of the image of the “park bench” (e.g., location of the park bench, type of surface of the park bench, presence of nature, foot traffic, etc.) and determine the predicted user configuration by selecting a reference from the database that correspond to the aspects of the selected image (e.g., outdoors, nature, cool breeze). In another example, the one or more processors can receive multiple selections from the sets of images of the sequence of sets of images. The one or more processors can use a weighting function or a machine learning model trained to determine or generate user configurations based on such selections to generate or determine a user configuration for a user that made the selections. The one or more processors can use the predicted user configuration to determine the subsequent sequence of sets of images as described above. The predicted user configuration can correspond to a respective user (e.g., the one or more processors can store an indication of the user configuration in a profile or data structure of the user). In some instances, the predicted user configurations can correspond to a plurality of users (e.g., the one or more processors can store an indication of the user configuration in a profile or data structure that corresponds to users with a defined set of attributes).

The method can include creating a training set (1225). The training set can be a script, corpus, or dataset that includes a plurality of examples to train a machine learning model. Each of the examples can include an instance of selections of images from the sequence of images or a different sequence of images, labels corresponding to the selected images, the predicted user configuration for the user, and an expected user configuration for the user. The expected user configuration for the user can be a user configuration that is indicated by the user. The expected user configuration can be the same as the predicted user configuration. In some instances, the expected user configuration can be different from the predicted user configuration. The one or more processors can create the training set prior to the execution of the machine learning model. The one or more processors can update or modify the training set subsequent to the execution of the machine learning model by including a subsequent predicted user configuration in the training set. Accordingly, the training set can be updated for iterative training to account for changes in preferences in images.

The method can include training a machine learning model (1230). The machine learning model can be a neural network or an artificial intelligence model (e.g., a generative model configured to generate images). The artificial intelligence model can be the model that generated the individual images of the sequence of images. The one or more processors can train the machine learning model using the training set to generate images and labels for the users. The one or more processors can apply or feed the selections of the images, the labels corresponding to the selected images, and a comparison between the predicted user configuration and the expected user configuration for each instance of the training data set. The comparison can indicate a delta or deviation from the expected user configuration and the predicted user configuration. The delta can tune or adjust the machine learning model to generate accurate images and corresponding labels for the images for each instance. The one or more processors can adjust the weights and/or parameters of the artificial intelligence model proportional to the difference or delta between the predicted user configuration and the expected user configuration. The output images and labels can be further compared to output images and labels within the training dataset.

In some cases, based on the comparison, the one or more processors can calculate, determine, or otherwise generate at least one loss metric. The loss metric can indicate a degree of deviation between the predicted user configuration and the expected user configuration. The loss metric may be generated in accordance with a loss function. The loss function can be at least one of mean squared error (MSE), mean average error (MAE), binary cross-entropy loss, categorical cross-entropy loss, Hinge Loss, or Wasserstein loss, among others.

Using the loss metric, the one or more processors can modify or adjust the plurality of weights of the ML model in accordance with an optimization function. For example, the one or more processors can use the loss metric to compute gradients for the direction and magnitude of weight adjustments to minimize the impact of the loss metric. The optimization function may be in accordance with stochastic gradient descent, and may include, for example, an adaptive moment estimation (Adam), implicit update (ISGD), and adaptive gradient algorithm (AdaGrad), among others

In a non-limiting example, the one or more processors can execute a generative machine learning model to generate a plurality of images and labels for the images to one or more processors. The images can correspond to pictures, environments, or situations in which a student may enjoy reading. The one or more processors can present (e.g., by transmitting to a computing device for presentation) a sequence of sets of images to a computing device of the student on a tablet. The student can iteratively select individual images from the different sets of images on the computing device. The images can relate to the favorite spots in which the students enjoy reading. The one or more processors can receive the selections of images. The one or more processors can determine a user configuration for the student based on the selections.

The one or more processors can use the selections by the student to train the generative machine learning model. For example, the one or more processors can aggregate the selections, labels of the selections, the predicted user configuration, and an expected user configuration (e.g., a ground truth configuration or reading preference) into a training data set with other instances of selections labels, predicted user configurations, and expected user configurations. The one or more processors can train the generating machine learning model by inputting the different instances of the training data set into the generative machine learning model. The one or more processors can train generative machine learning model by adjusting the weights and/or parameters of the generative machine learning model proportional to the differences between the predicted user configurations and the corresponding expected user configurations. In this way, the one or more processors can then use the training dataset to train the machine learning model to generate images for students that can more accurately be used to determine user configurations for the students.

In another example, the one or more processors can store a database of 8,000 reading environment photographs along with corresponding descriptive labels such as “bright coffee shop with large windows,” “quiet home office with desk lamp,” “outdoor park bench under tree shade,” and “dimly lit bedroom with bedside reading light.” Each label indicates specific environmental characteristics including lighting conditions, noise levels, seating arrangements, and atmospheric qualities that define different reading contexts. The one or more processors may organize this collection to represent diverse reading environments that users might encounter or prefer for their reading activities.

The one or more processors can present a sequence of sets of reading environment images from the stored collection on a user interface displayed at a user device, such as a reading app on a tablet or smartphone. Each set may contain 5-6 images representing different categories like “Morning Reading Spots,” “Evening Comfort Zones,” “Public Reading Spaces,” or “Private Study Areas.” The one or more processors may display these sets one at a time, allowing users to browse through various environmental options systematically. Users can view images showing different lighting conditions, from bright natural sunlight streaming through café windows to soft lamplight in cozy living room corners.

The one or more processors can receive a selection of one preferred image from each presented set directly from the user device through touch interactions or clicks. For example, a user might select “sunny window seat with soft cushions” from the morning reading set, “quiet library corner with warm lighting” from the study environment set, and “comfortable outdoor hammock in shade” from the recreational reading set. The one or more processors may record these selections along with their associated environmental characteristics, building a profile of the user's preferred reading conditions across different scenarios and times of day.

The one or more processors can determine a predicted user configuration based on the pattern of selected images and their corresponding labels, analyzing factors such as consistent preference for natural lighting, quiet environments, or comfortable seating arrangements. Through algorithmic analysis, the one or more processors may identify that a user consistently chooses well-lit, quiet spaces with comfortable seating, leading to a predicted user configuration of “prefers bright, peaceful environments with ergonomic seating and minimal distractions.” The one or more processors can compare this prediction against an expected user configuration (e.g., a ground truth value that may have been input from user profile data, demographic information, or previously stated preferences to assess accuracy).

The one or more processors can create a training set that includes the user's image selections, the environmental labels of those selected images, the algorithmically predicted user configuration, and the expected user configuration for comparison purposes. Using this training data, the one or more processors can train a neural network to generate new reading environment images and corresponding descriptive labels. The trained model may learn to create images of personalized reading spaces such as “softly illuminated corner chair near large window with reading table” or “peaceful garden nook with dappled sunlight and cushioned bench,” generating contextually appropriate environments that align with the user's demonstrated preferences while accounting for variations between predicted and expected preference patterns.

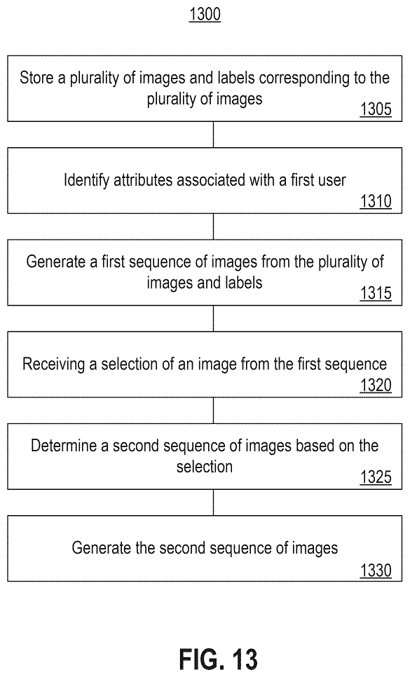

FIG. 13 illustrates a flow diagram of a method 1300 for generating images and labels for students and teachers. The method 1300 can be implemented by any of the various components described in system 100. The method can include storing a plurality of images and labels corresponding to the plurality of images (1305). Each of the plurality of images can include a collection of pixels to represent visual data. The plurality of images can be extracted from a plurality of data sources (e.g., web domains, websites, web browsers, web pages). The plurality of images can be captured by one or more individuals and uploaded to the respective data source or generated by one or more machine learning models (e.g., machine learning model 130). The one or more processors can store each of the plurality of images within a database or data repository. Each of the plurality of labels can map or link to an image of the plurality of images. The label can be a description or prompt to describe or summarize the image.

The method can include identifying attributes associated with the first user (1310). The one or more processors can identify the attributes based on interactions with an application executing on the user device. The application can be configured to display a user interface in accordance with one or more instructions from the one or more processors. The user interface can include a plurality of user interface (UI) elements configured to receive the interactions. The application can use the UI elements to display a text box, an input box, a slider, a notification, or a prompt, among other user inputs. The one or more processors can receive a user input corresponding to an assessment, questionnaire, or a message displayed on the application. The one or more processors can parse a text input of the user input to identify the attributes of the user. The attributes can correspond to or include demographic information, reading preferences, ancestry, geographic information (e.g., geographic location) hobbies, strengths, and weaknesses, among other information associated with the user. The one or more processors can identify the attributes for each user accessing the application (e.g., user on a phone, user on a tablet).

The method can include generating a first sequence of sets of images for presentation at a user device (e.g., first user device) (1315). The one or more processors can present the labels corresponding to each image in the first sequence of sets of images. The first sequence of sets of images can include one or more images that display or indicate a place or environment for a user (e.g., student or teacher) to read in. Each image can be in accordance with the attributes associated with the user. For example, the attributes for a user can indicate that the user is from Naples, Florida. The one or more processors can indicate (e.g., in a defined attribute for the set of images) that the context of the set of images can correspond to or be associated with Naples, Florida (e.g., the images may be of places within Naples, Florida, the images may be of items that are in Naples, Florida, the images may correspond to labels using language or words (e.g., bathroom versus washroom) that are used in Naples, Florida, etc.). The one or more processors can access the one or more web sources to identify the context associated with Naples, Florida (e.g., the beach, clouds, soft textures, Palm trees). The one or more processors can access the database to extract and present images and/or labels for the images that include the context of the images.

The method can include receiving selections of images from the first sequence of sets of images (1320). The one or more processors can receive the selections of images from the sequence of sets of images based on interactions with the user device. The user device can detect the interactions with one or more graphical user interface elements associated with an image of each set of images of the sequence of sets of images as the different sets of images are displayed on a user interface of the user device. For example, the one or more processors can iteratively present the different sets of images at the user device. A user accessing the user device can select an image from each presented set of images. Based on the interactions, the one or more processors can register the interactions as the selections of the images. The interactions can be or include at least one of a button press, a click, a search of an image, or a removal of images. The one or more processors can assign a weight to each image in the first sequence of images, the weight corresponding to a likelihood of selection by the user. In response to the selection of an image, the one or more processors can modify the weight of the selected image to a first weight that is greater than the weight assigned to each other image, thereby prioritizing images similar to those previously selected by users. The one or more processors can decrease the weight of the non-selected images, thereby making less likely to present those images again in subsequent presentations of sequences of images.

The method can include determining a second sequence of sets of images based on the selections (1325). The second sequence of sets of images can be different from the first sequence of images. The one or more processors can determine the second sequence of sets of images based on the selections of the images at the first user device and the attributes of the second user. In one example, the one or more processors can display or present, at the first user device, a sequence of sets of images corresponding to a “couch,” “bean bag,” and “grass,” respectively. The one or more processors can receive a selection of the “couch” from a set of images of the sequence. Based on the selection, the one or more processors can increase a weight for the selected image and decrease weights of the other images in the same set of images. The weights can indicate or correspond to a likelihood of a user interacting with the respective images. The one or more processors can similarly increase and decrease weights for the images of each set of images of the sequence as the user makes his or selections. The one or more processors can store the adjusted weights in a profile that corresponds to the attributes of the user. The one or more processors can similarly adjust the weights for the images for the attributes as other users with the same or similar (e.g., having a similarity within a threshold of the attributes of the user) similarly make selections of the images. Subsequently, the one or more processors can use the weights to select or generate sets of images to include in the sequence of the sets of images, such as by only including images in the sets with weights above a threshold and/or otherwise selecting images to include in sets based on the weights (e.g., by selecting images based on the weights of images in descending order). The one or more processors can determine a second user operating a second user device has attributes that are the same as or that are within a similarity threshold of the attributes of the profile. The one or more processors can present the sequence of the sets of images generated based on the selections at the first user device.

In another example, the one or more processors can use the selections to train a machine learning model (e.g., a generative machine learning model). For example, the one or more processors can train a machine learning model based on only on interactions by users that have the attributes of the profile described above or that are within a distance threshold of the attributes of the profile. The one or more processors can train the machine learning model by feeding the selected images into the machine learning model with indications that the images were correct or selected images. The one or more processors can train the machine learning model to generate images similar to the selected images by adjusting the weights and/or parameters based on the input selected images. The one or more processors can subsequently generate a plurality of images (e.g., a second plurality of images) and/or labels for the images for presentation at a second user device being accessed by a user with attributes that match or are within a distance threshold of the attributes of the profile used to train the machine learning model. Accordingly, the one or more processors can train the machine learning model to generate images and/or labels specific to users that have the attributes of a particular profile.

The method can include generating the second sequence of sets of images for presentation at a user device (e.g., a second user device) (1330). The one or more processors can generate the user interface to present the second sequence of sets of images for the second user. The one or more processors can present the second sequence of sets of images and labels corresponding to the second sequence of images. The second sequence of sets of images can be displayed on the user device associated with the second user (e.g., different student from the first student) iteratively while the second user selects different images from the sets. In this manner, the systems and methods described herein can use sequences of images and attributes of each user to determine sequences of images and attributes of a new or subsequent user.

In a non-limiting example, a server (e.g., server 106) can transmit a plurality of images and labels for the images to one or more processors (e.g., image manager 118). The images can correspond to pictures, environments, or situations that a student may enjoy reading in or a teacher finds relatable. The server 106 can identify demographics for the student or teacher that can indicate images the student can prefer to see. Using the demographics, one or more processors (e.g., image manager 118 or interface generator 120) can present images and labels to the students or teachers in accordance with their demographics on the phone of the student or teacher. The student and the teacher can select images that they prefer to see. The one or more processors can determine more images, based on the selections of images by using a machine learning model (e.g., machine learning model 130). In this manner, the teachers and students can continuously see images they prefer.

This method can resolve the technical problem of cold-start recommendations for new users or users with limited interaction history by leveraging the selection patterns of similar users while accounting for individual attribute differences. The system can implement dynamic weight assignment mechanisms that adjust or change based on user selections, enabling more accurate cross-user preference inference and reducing the computing resources that are needed for generating personalized content for individual users.

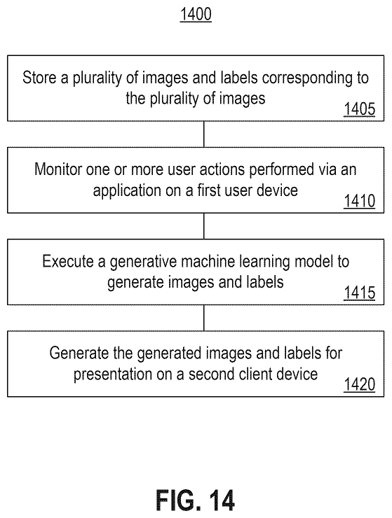

FIG. 14 illustrates a flow diagram of a method 1400 for using machine learning to determine images and labels for users (e.g., administrator, schoolteacher, et.) to use for instruction. The method 1400 can be implemented by any of the various components described in system 100. The method can include storing a plurality of images and labels corresponding to the plurality of images (1405). Each of the plurality of images can include a collection of pixels to represent visual data. The plurality of images can be extracted from a plurality of data sources (e.g., web domains, websites, web browsers, web pages). The plurality of images can be captured by one or more individuals and uploaded to the respective data source or generated by one or more machine learning models (e.g., machine learning model 130). The one or more processors can store each of the plurality of images within a database or data repository. Each of the plurality of labels can map or link to an image of the plurality of images. The label can be a description or prompt to describe or summarize the image.

The method can include monitoring one or more user actions performed via an application on a first user device (1410). The user device can be executing the application that configures one or more user interfaces. Each user interface can be configured to execute one or more user interface (UI) elements. Each of the UI elements can be configured to receive interactions with the user device. For example, the UI elements can receive a button press, a swipe, a long press, an audio signal, a text input, among other interactions with the user device. Each interaction can correspond to the one or more user actions. The user actions can include a selection of an image, a rejection of the image, a modification to an image (e.g., a change in color, object, scenery, etc., of the contents of the image), or other adjustments to the sequence of images. For example, the application can use the user interface to present sequences of sets of images that are selected or otherwise interacted with by users for user configuration determination. In some cases, the interactions can correspond to button presses as the user interacts with the application, such as by navigating through different menus or by updating the settings of the application.

The method can include executing a generative ML model to generate images and labels (1415). The one or more processors can execute the generative ML model to generate images and labels that can be used for user configuration determination, as described herein.

Prior to execution, the one or more processors can train the generative ML model using the one or more user actions detected during the monitoring step. For instance, the one or more processors can provide the ML model with indications of the user actions as an input. In some instances, the ML model can provide the ML model with images that were accepted (e.g., indicated to be included in a set of images), rejected (e.g., indicated not to be included in a set of images or removed for the set of images), or modified, with indications of what the user actions were with respect to the images. The ML model can provide the ML model additionally with labels indicating the content of the images of the interactions. The one or more processors can include interactions in the input into the ML model. The one or more processors can train the ML model based on the input, such as by making it more likely to generate images that are similar to the accepted or modified and less likely to generate images that are rejected. In some cases, the user actions can be included to adjust the weights and/or parameters of the ML model. In some cases, the one or more processors can train different ML models in this way for users with specific sets of attributes (e.g., of a profile of attributes) for image generation for sequences of images for subsequent users with the same or similar (e.g., within a similarity threshold), as described herein. Accordingly, the one or more processors can train the ML model to generate images that are preferable to subsequent users and/or that are preferable by another entity (e.g., a teacher can modify images according to the teacher's preferences for user configuration determination of the teacher's students).

The method can include generating a user interface including the generated images and labels for presentation on a second client device (1420). The one or more processors can generate the user interface to present the generated images and labels for the second user. The generated images can be displayed on the user device associated with the second user (e.g., different student from the first student). In some instances, an authorized user can approve or reject the generated images. The approval or rejection of the images can indicate a presence of inappropriate content or bias within the output. By receiving an indication of the approval or rejection, the one or more processors can further provide the indication to the ML model to incorporate within the loss metric. In this manner, the ML model can avoid generating inappropriate, irrelevant, or biased images during execution.

In a non-limiting example, a server (e.g., server 106) can transmit a plurality of images and labels for the images to one or more processors (e.g., image manager 118). The images can correspond to pictures, environments, or situations that a teacher may user for instruction. The one or more processors (e.g., interaction manager 122) can monitor the actions of the teacher when presented with sequences of sets of images. The teacher can remove images that do not relate to the instruction in the classroom and add images that better relate to the instruction within the classroom. The teacher can change labels of the images to use labels in accordance with the reading level of the students, the location of the school district, where the teacher grew up, among others. The one or more processors (e.g., model manager 128) can execute a generative ML model to generate new images and label based on the previous adjustments of the teacher. In this manner, the systems and methods described herein can use a ML model to quickly generate images similar to previously selected images to avoid the cumbersome and expensive need to access a plurality of web sources, identify relevant images, load the images, and store the images within the database. The systems and methods described herein save time and reduce computer expense by training the ML model to automatically generate the images for the respective users.

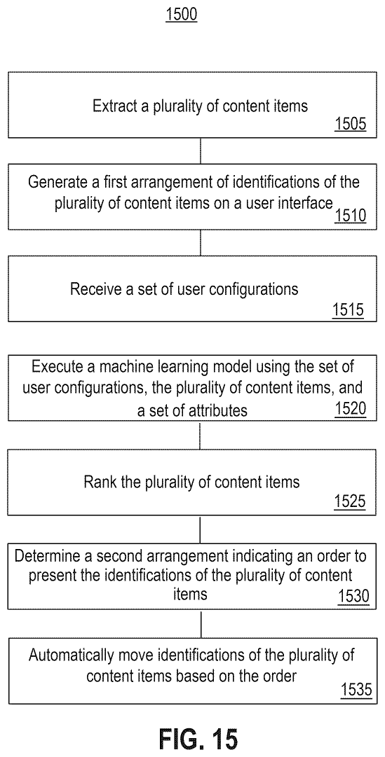

FIG. 15 illustrates a flow diagram of a method 1500 for using ML to analyze items in a content repository to produce a ranked list of item recommendations. The method 1500 can be implemented by any of the various components described in system 100. The method can include extracting (e.g., identifying or retrieving) a plurality of content items (1505). The plurality of content items can represent content, a description, or information associated with a book, for example. The content of the book can be or correspond to the genre, summary, introduction, or the title of the book. Each of such aspects can be or include attributes of the book. In some cases, the one or more processors can extract or identify the content items based on the attributes. For example, the one or more processors may parse different content items (e.g., books) in a data repository and determine values of the attributes for the respective content items. In some cases, the one or more processors can access the data repository to identify the plurality of content items for the user by transmitting a request to a server (e.g., a remote server). The request can include the plurality of content items, the attributes of the user, the user configurations of the user, and authorization credentials for the user initiating the request. The server can provide the request to a library management system for access to each of the plurality of content items, for example.

The method can include generating a first arrangement of identifications of the plurality of content items on the user interface of the user device (1510). The arrangement can indicate a format of the plurality of content item displayed on the user interface. The format of the arrangement can be based on a location, a size, a transformation, a priority, ordering within a list among other forms of indications of arrangement. The one or more processors can automatically modify or adjust the arrangement at various intervals of time, upon detection of changes to the user configurations, or manually by a user.

The method can include receiving a set of user configurations (1515). The set of user configurations can indicate a location, an environment, or setting in which a user prefers to read a book, why they like to read, where they like to learn new words, etc. The one or more processors can receive the set of user configurations from the application executing on the user device. The user can be presented with a survey, questionnaire, prompt, set of images, among others to identify the user configurations. In a similar manner, the one or more processors can receive a set of attributes associated with the user. The attributes can correspond to or include demographic information, user configurations, ancestry, hobbies, strengths, weaknesses, among other information associated with the user.

The method can include executing a machine learning model (e.g., a neural network or a regression model) using the set of user configurations, the plurality of content items, and the set of attributes (1520). Upon execution, the machine learning model can generate a user configuration score for each of the plurality of content items.

The machine learning model can be trained to generate the user configuration score for each of the plurality of content items using a training dataset. The training dataset can include user configurations, content items, and/or attributes of different content items for respective. The one or more processors can feed or input the training dataset to the ML model to train the machine learning model to cause the machine learning model to generate predictive user configuration scores for the different content items. The user configuration score can correspond to a likelihood of the user interacting with the content item.

The method can include ranking the plurality of content items (1525). The one or more processors can rank the plurality of content items according to the user configuration score generated by the machine learning model. The ranking can be a number or value assigned to a respective content item to indicate the likelihood of the user interacting with the content item. To rank the plurality of content items, the one or more processors can modify a data structure that houses each content item associated with a user of the application. In modifying the data structure, the one or more processors can adjust a field within the data structure to include the ranking for each content item. The one or more processors can rank the content items based on the user configuration scores assigned to the content items, such as by ranking content items associated with user configuration scores associated with higher user configuration scores higher than content items associated with lower user configuration scores.

The method can include determining a second arrangement indicating an order to present the identifications of the plurality of content items (1530). The subsequent arrangement can be different from the arrangement of the plurality of content items displayed on the user interface. In some cases, the subsequent arrangement can be the same as the arrangement of the plurality of content items displayed on the user interface. The subsequent arrangement can indicate an order to present the identifications of the plurality of content items on the user interface. The order can be based on the ranking assigned to each of the plurality of content items. The order can correspond or map to a plurality of positions within the user interface. The plurality of positions can include, for example, a center, proximal to a specific icon, a corner, a leftmost portion, a rightmost portion, on top of a list, a bottom of a list, medial within the list, among ither positions within the user interface of the user device.

The method can include automatically moving the identifications of the plurality of content items based on the order (1535). The one or more processors can present the identifications on the user interface of the user device in the order that is determined according to the rankings of each of the plurality of content items (e.g., in ascending or descending order based on the rankings) . . . . For example, each content item can be assigned a value that corresponds to the ranking. The one or more processors can generate a data structure (e.g., queue, a linked list, array) using the value assigned to the plurality of content items. For example, the data structure can be a queue. The queue can be a first in-first-out queue such that content items with the lowest value (e.g., rank of 0, rank of 1, rank of 2) are loaded into the queue. The one or more processors can use the position of each content item within the queue to establish the order and present identifications of the plurality of content items on the user interface.

In a non-limiting example, the one or more processors (e.g., interaction manager 122) can receive a set of user configurations from a tablet of a student. While the student selects the set of user configurations, the one or more processors (e.g., content manager 132) can extract books from a libraries database (e.g., data repository 110) that include content associated with the user configurations of the student. The one or more processors (e.g., model manager 128) can execute an ML model to generate a user configuration score for each book in the library. Based on the user configuration score, the one or more processors can rank the books in the library. From here the student can receive an ordered list of books that are ranked such that the student may have an interest in reading the books at the top of the list. In this manner, the systems and methods described herein.

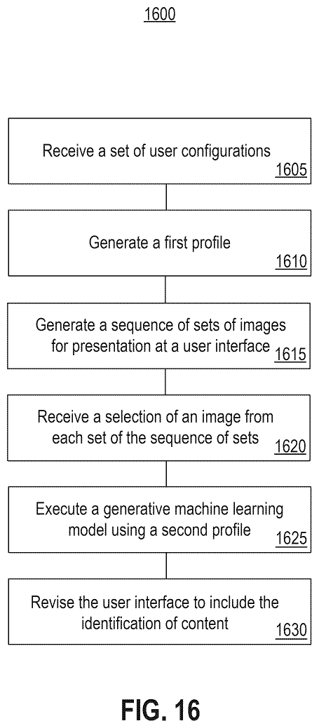

FIG. 16 illustrates a flow diagram of a method 1600 for using profiles for students as an input to ML to generate recommendations for reading conditions. The method 1600 can be implemented by any of the various components described in system 100. The method can include receiving a set of user configurations for each of a plurality of first users (1605). The set of user configurations can indicate a location, an environment, or setting in which a user prefers to read a book. The one or more processors can receive the set of user configurations from the application executing on the user device. The user can be presented with a survey, questionnaire, prompt, set of images, among others to identify the user configurations. In a similar manner, the one or more processors can receive a set of attributes associated with the user. The attributes can correspond to or include demographic information, reading preferences, ancestry, hobbies, strengths, weaknesses, among other information associated with the user.

The method can include generating a first profile (1610). The first profile can be a data structure to store or otherwise maintain information for a first user. Each user of the plurality of first users can include a profile within the data repository. The data structure can correspond to an array, a linked list, a tree, a nodal data structure, among other data structures to maintain information about the user. The one or more processors can use the set of user configurations and the set of attributes to generate a profile for each user (e.g., by storing the set of attributes and user configurations in the data structures of the profiles of the users). The one or more processors can store the profiles in a spatial locality based on similarities between the set of user configurations or the set of attributes.

The method can include generating a sequence of sets of images for presentation (1615). The sequence of sets of images can include at least a subset of the plurality of images. The sequence of sets of images can be based on one or more attributes associated with a user of a user device. The user can be a student, teacher or administrator controlling or handling the user device. The user device can be at least one of a phone, computer, tablet, among other smart devices compatible with a user interface. The one or more attributes can indicate or define demographic information, reading preferences, ancestry, hobbies, strengths, weaknesses, among other information associated with the user. The one or more processors can identify the one or more attributes based on interactions with the user device. The interactions can correspond to an action at the user interface of the user device. For example, a student can interact with (e.g., provide inputs into) the user device indicating that the student grew up on a farm. various aspects and information associated with a farm (e.g., barns, crops, agriculture, farm animals) can be stored as an attribute for the student. The one or more processors can present a sequence of sets of images in accordance with the conditions (e.g., animals, sounds) of the farm. In some instances, the one or more processors can generate a user interface to display the sequence of sets of images.

The method can include receiving a selection of an image (1620). The one or more processors can receive the selection of an image from the sequence of sets of images based on interactions with the user device. The one or more processors can generate or identify a subsequent sequence of sets of images based on the previous selection. The subsequent sequence of sets of images can include the previously selected image and other images similar (e.g., images similar to a couch, images similar to an open field, etc.) to the previously selected image. Each image in the sequence can be extracted from the data repository or generated by a machine learning model. The user device can detect the interaction with one or more graphical user interface elements associated with the image displayed on the user device. Based on the interaction, the one or more processors can register the interaction as the selection of the image.

In one example of performing steps 1615 and 1620, when presenting the sequence of sets of images, the one or more processors can iteratively present different sets of images in order. For example, the one or more processors can present a first set of images at the user device. The first set of images can include a defined number of images. The one or more processors can receive a selection (e.g., a user selection) from the first set of images. Responsive to receiving the selection, the one or more processors can present a second set of images. The one or more processors can receive a selection from the second set of images. Responsive to receiving the selection, the one or more processors can present a third set of images. The one or more processors can repeat this process for each set of images of the sequence. The one or more processors can store an indication of the selected image for each selection

The method can include executing a generative machine learning model using a second profile (1625). The second profile can be different from the first profile. In some instances, the one or more processors can transmit the information to the server within a request. The reception of the request can cause the server to identify or generate the one or more recommendations by accessing a library management system to select content that relates to the information of the user. The one or more processors can execute the generative machine learning model to generate an identification of content for a second user mapped to the second profile.

The generative machine learning model can be trained using the profiles for the plurality of first users within the data repository. In training, the generative machine learning model can use a respective profile to determine one or more identifications of content for each respective user of the profiles and adjust the weights and/or parameters of the generative machine learning model based on whether the user approved the recommendation or not. In some cases, to determine the one or more recommendations, the generative machine learning model can extract the information of the user which includes the set of user configurations, the attributes, and other information about the user. The generative machine learning model can identify or generate mappings between the information of the user and possible recommendations via a neural network. Using the mappings, the generative machine learning model can identify the one or more recommendations for the user by identifying the mapping with the greatest probability of occurrence within the neural network.

The generative machine learning model can receive feedback from user devices to correct or adjust the recommendations based on the profile. The one or more processors can use the feedback to generate a loss metric to apply to the generative machine learning model. The one or more processors can the one or more processors can calculate, determine, or otherwise generate the at least one loss metric. The loss metric can indicate a degree of deviation between the output of the ML model and the expected output as in the training dataset (e.g., accurate recommendations). The loss metric may be generated in accordance with a loss function. The loss function can be at least one of mean squared error (MSE), mean average error (MAE), binary cross-entropy loss, categorical cross-entropy loss, Hinge Loss, or Wasserstein loss, among others.

Using the loss metric, the one or more processors can modify or adjust the plurality of weights of the ML model in accordance with an optimization function. For example, the one or more processors can use the loss metric to compute gradients for the direction and magnitude of weight adjustments to minimize the impact of the loss metric. The optimization function may be in accordance with stochastic gradient descent, and may include, for example, an adaptive moment estimation (Adam), implicit update (ISGD), and adaptive gradient algorithm (AdaGrad), among others. The one or more processors can repeat multiple iterations of training until the generative ML until convergence.

The method can include revising the user interface to include the identification of content (1630). The one or more processors can revise the user interface to display the identification of content. The identification can be in accordance with the user configurations and attributes of the user. For example, for a user that is from New York City and prefers to read with background noise, the identification can indicate that the user read a book regarding the impacts of a major city on a human body. The identifications can be presented in a list based on the one or more weights assigned to each user configuration. The one or more processors can present the identifications within the application executing on the user device.

In some cases, revising the user interface can include determining whether to show or move the identification of the content on the user interface. The one or more processors can do so, for example, based on a confidence score for the identification of the content. For instance, when the generative machine learning model generates the identification of the content for the second user, the generative machine learning model may determine a confidence or probability for the content. The generative machine learning model may do so based on the learned weights and/or parameters of the generative machine learning model. The generative machine learning model may generate the identifications of the content responsive to determining the probability or confidence score exceeds a threshold (e.g., a first threshold), for example.

The one or more processors can identify the confidence score or probability and use the probability to determine whether and/or how to revise the user interface. For instance, the one or more processors can compare the confidence score or probability to a tiered set of threshold including two thresholds. A lower threshold can correspond to whether to present an identification of the content on the user interface at all, and the higher threshold can correspond to a location to place the identification of the content on the user interface. The one or more processors can compare the confidence score or probability to the lower threshold and the higher threshold. Responsive to determining the confidence score or probability is lower than the lower threshold, the one or more processors can determine not to update or revise the user interface. Responsive to determining the confidence score is in the middle of the two thresholds, the one or more processors can determine to place the identification of the content in a dedicated location of the user interface for identifications of content. Responsive to determining the confidence score or probability exceeds the higher threshold, the one or more processors can determine to move the elements on the user interface around to place the identification of the content in a highly visible location (e.g., in the middle) of the user interface. In some cases, the one or more processors can format the identification based on the confidence or probability, such as by placing the identification to have a size that positively correlates with the probability or confidence (e.g., a size that scales with the confidence or probability or a size that is assigned for probabilities or confidence scores between the two thresholds and a size that is assigned for probabilities or confidence scores higher than the higher threshold). The one or more processors can revise the user interface in any manner.

In a non-limiting example, the one or more processors (e.g., interaction manager 122) can receive a set of user configurations and characteristics of a student from a student's tablet. The one or more processors (e.g., profile generator 134) can generate a profile for the student. The profile can be displayed on the user interface of a teacher. The one or more processors (e.g., model manager 128) can execute a ML model using the profiles to generate a recommendation for books for each student within the classroom. From here, the one or more processors (e.g., interface generator 120) can present recommendations for books for the students.

In this manner, the systems and methods described herein can utilize the generative machine learning model to generate recommendations for students without the need to query library management systems or the data repository to find content for the student. By eliminating this need, the systems and methods described herein can save computing resources and improve processing efficiency for processing the set of user configurations, tributes, and content items associated with the users.

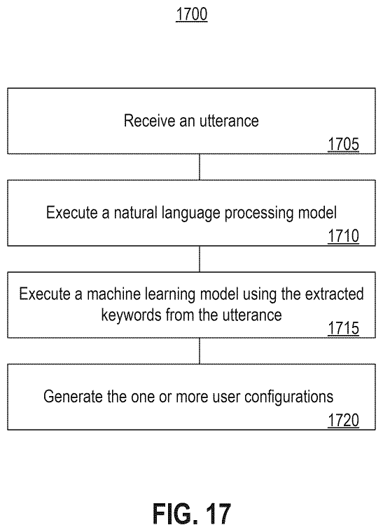

FIG. 17 illustrates a flow diagram of a method 1700 for using words spoken by students as an input to ML to determine user configurations of students. The method 1700 can be implemented by any of the various components described in system 100. The method can include receiving an utterance (1705). The utterance can include a plurality of words from a user device. The user device can detect the utterances via a microphone or another audio capture device. The user device can transcribe the utterance based on the audio data of the individual speaking. The one or more processors can maintain a plurality of keywords that indicate a user configuration within the data repository. Based on the plurality of keywords, the one or more processors can identify (e.g., based on a mapping between keywords and user configurations or a set of rules that correspond to user configurations and can be satisfied based on keywords) user configurations spoken by the user.

The method can include executing a natural language processing model (1710). The natural language processing model can be at least one of a Rule-based Model, a Statistical Model, or a Deep Learning Model. The natural language processing model can extract the plurality of keywords from the utterance. The natural language processing model can compare the keywords of the utterance to the keywords stored within the data repository. In response to a match, the one or more processors can flag the keyword as indicating a user configuration for the user.

The method can include executing a machine learning model using the extracted keywords from the utterance (1715). The extracted keywords can be input or fed to the machine learning model for the machine learning model to generate the one or more user configurations of the user. The machine learning model can be trained based on a training set that includes a plurality of keywords that are mapped to one or more user configurations. The machine learning model can be trained based on matches between the keywords stored in the data repository and the keywords of sample utterances. The machine learning model can determine or identify mappings between the keywords and indications of user configurations. For example, the one or more processors can provide a plurality of keywords that correspond to a user configuration within the data repository to the machine learning model. The machine learning model can generate embeddings for a first keyword which indicate a set of user configurations associated with the keyword. From here, the machine learning model can generate embeddings for a second keyword to narrow the set of user configurations associated with the first keyword. At each iteration, the machine learning model can use the embeddings to indicate or establish mappings between each keyword and the set of user configurations. The machine learning model can repeat this process for each keyword in the utterance. Using the mappings, the machine learning model can generate the one or more user configurations (e.g., reading preferences).

In some instances, the keywords provided to the machine learning model are not in the database as there is no mapping available. Based on this occurrence, the machine learning model can automatically update the database to include the keywords not included in the database. By updating the database, the machine learning model can generate new mappings or nodes (e.g., via a neural network) for each of the keywords recently stored within the database. Furthermore, the ML model can remove or delete keywords that arise from authorized users as these keywords can introduce bias into the ML model. The ML model can remove the bias by identifying one or more keywords as an outlier based on the neural network. Furthermore, the one or more processors can identify the keywords as being spoken by an authorized user of the application and not a student.

The method can include generating a user interface including the one or more user configurations for presentation (1720). The one or more processors can generate the user interface to present one or more user configurations of the user. The one or more user configurations can be presented on the application executing on the user device. The one or more processors can further display the keywords mapped to the user configurations. In some cases, the user interface can display a number of occurrences of each keyword for the user.

In a non-limiting example, a student can have a conversation with a teacher that is recorded on a computing device. From the conversation, the one or more processors (e.g., audio processor 138) can receive data associated with the words spoken by the student. A natural language processing model (e.g., NLP model 136) can extract keywords from the student. The natural language processing model can extract keywords, such as “outside,” “balcony,” “car,” among others, which indicate a user configuration. The one or more processors (e.g., model manager 128) can execute the ML model (e.g., ML model 130) to generate one or more user configurations based on the conversation with the teacher. In this manner, the systems and methods described herein can reduce processing power by capturing and storing keywords spoken by the one or more users instead of storing all words spoken in the utterance. Furthermore, the systems and methods described herein can actively update the database with keywords not spoken in a prior utterance while removing bias and outliers associated with users who are not students.

A reading identity can be specifically and distinctly from more traditional or demographic-based interpretations of identity. For example, reading identity can refer to how students see themselves as readers and understand their reading preferences. More specifically, a reading identity can indicate a student's preferred reading content, learning conditions, and engagement modalities. This usage can be distinct from common interpretations of identity that emphasize phenotypical, cultural, ethnic, or racial characteristics. While such factors may inform student preferences, the system described herein can identify a student's reading identity through individualized reading behaviors and preferences, not static demographic traits.

Determining students' reading identities can influence classroom and administrative decision-making beyond instructional personalization. For example, the system can store a student's reading preferences (e.g., user configurations) in a profile for the student. The profile can be used to inform instructional decisions, classroom grouping, culturally responsive content selection, family engagement strategies, and school or district procurement of supplemental reading materials and programs.”

The technology described herein can be grounded in a proprietary pedagogical framework that integrates early literacy development with social-emotional learning (SEL) to create profiles for students indicating their reading preferences. These profiles can serve as a dynamic, multi-dimensional representation of a student's relationship with reading. Unlike traditional adaptive systems that focus solely on comprehension or decoding, the technology can measure and support six core domains (e.g., different types of user configurations) of reading identity: reading preferences, reading confidence, reading motivation, reading agency, reading belonging, and reading self-awareness. These domains, each tied to measurable core competencies, are informed by leading SEL frameworks, including the collaborative for academic, social, and emotional learning (CASEL) and Harvard's Explore SEL. The result is a holistic profile that personalizes learning based not only on skill level, but also on affective and identity-based indicators.

Moreover, by implementing the systems and methods described herein, a system can generate and update a reading identity profile that guides personalization of reading instruction, content delivery, and school procurement. The system can collect behavioral, preference-based, and self-reflective input from students across six identity domains and maps this data to discrete core competencies. These competencies enable the platform to recommend content and scaffold instruction in a culturally responsive and emotionally resonant manner. The personalization engine is designed to reflect student voice and choice, building reading motivation and confidence through multimedia, self-assessment, and AI-driven content alignment. The technical improvements described herein can allow for a student-centered personalization model that supports both academic growth and social-emotional development-particularly for vulnerable student populations who may have experienced reading trauma or disengagement.

At least one aspect of the present disclosure relates to a method. The method can be performed, for example, by one or more processors coupled to non-transitory memory. The method can include storing a plurality of images and labels corresponding to the plurality of images in a database, each label indicating content of an image corresponding to the label. The method can include identifying attributes associated with a first user of a first user device and a second user of a second user device. The method can include presenting a first sequence of sets of images from the plurality of images and labels corresponding to each image in the first sequence of sets of images on a first user interface of the first user device, the first sequence of sets of images determined based on the attributes associated with the first user. The method can include receiving a selection of an image from the first sequence of sets of images, from the first user device. The method can include determining a second sequence of sets of images based on the selection of the image from the first sequence of sets of images at the first user device and the attributes of the second user. The method can include presenting the second sequence of sets of images and labels corresponding to the second sequence of sets of images on a second user interface on the second user device.

In some implementations, the method can include training a machine learning model to generate a second plurality of images and labels corresponding to the images using a training set based on the selection of the image and the attributes associated with the first user. In some implementations, the method can include generating, using the machine learning model, the second plurality of images and labels corresponding to the images. In some implementations, the method can include presenting the second plurality of images and labels corresponding to the images. In some implementations, the attributes of the first user comprises demographic information, geographic information, and cultural information.

In some implementations, the method can include generating a second user interface to present the second sequence of sets images and labels, the second user interface including one or more graphical user interface elements to receive interactions with the labels. In some implementations, the method can include assigning a weight to each image in the first sequence of images, the weight corresponding to a likelihood of selection by the user. In some implementations, the method can include, in response to the selection of the image, modifying the weight of the image to a first weight that is greater than the weight assigned to each image. In some implementations, the method can include determining the second sequence of sets of images based on the selection of the image from the first sequence of sets of images at the first user device, the attributes of the second user, and the weight assigned to each image.

In some implementations, the method can include receiving a second selection of an image from the second sequence of sets of images, from the first user device. In some implementations, the method can include determining a third sequence of sets of images based on the selection of the image from the second sequence of sets of images at the first user device and the attributes of the second user. In some implementations, the method can include presenting the third sequence of sets of images and labels corresponding to the third sequence images on the second user interface on the second user device.

At least one aspect relates to a system. The system can include one or more processors coupled with memory. The system can store a plurality of images and labels corresponding to the plurality of images in a database, each label indicating content of an image corresponding to the label. The system can identify attributes associated with a first user of a first user device and a second user of a second user device. The system can present a first sequence of sets of images from the plurality of images and labels corresponding to each image in the first sequence of sets of images on a first user interface of the first user device, the first sequence of sets of images determined based on the attributes associated with the first user. The system can receive a selection of an image from the first sequence of sets of images, from the first user device. The system can determine a second sequence of sets of images based on the selection of the image from the first sequence of sets of images at the first user device and the attributes of the second user. The system can present the second sequence of sets of images and labels corresponding to the second sequence of sets of images on a second user interface on the second user device.

In some implementations, the system can train a machine learning model to generate a second plurality of images and labels corresponding to the images using a training set based on the selection of the image and the attributes associated with the first user. In some implementations, the system can generate, using the machine learning model, the second plurality of images and labels corresponding to the images. In some implementations, the system can present the second plurality of images and labels corresponding to the images. In some implementations, the attributes of the first user comprises demographic information, geographic information, and cultural information.

In some implementations, the system can generate a second user interface to present the second sequence of sets images and labels, the second user interface including one or more graphical user interface elements to receive interactions with the labels. In some implementations, the system can assign a weight to each image in the first sequence of images, the weight corresponding to a likelihood of selection by the user. In some implementations, the system can, in response to the selection of the image, modify the weight of the image to a first weight that is greater than the weight assigned to each image. In some implementations, the system can determine the second sequence of sets of images based on the selection of the image from the first sequence of sets of images at the first user device, the attributes of the second user, and the weight assigned to each image.

In some implementations, the system can receive a second selection of an image from the second sequence of sets of images, from the first user device. In some implementations, the system can determine a third sequence of sets of images based on the selection of the image from the second sequence of sets of images at the first user device and the attributes of the second user. In some implementations, the system can present the third sequence of sets of images and labels corresponding to the third sequence images on the second user interface on the second user device.

At least one aspect relates to a non-transitory computer readable medium including computer readable instructions. The instructions, when executed by one or more processors, can cause the one or more processors to store a plurality of images and labels corresponding to the plurality of images in a database, each label indicating content of an image corresponding to the label. The instructions can cause the one or more processors to identify attributes associated with a first user of a first user device and a second user of a second user device. The instructions can cause the one or more processors to present a first sequence of sets of images from the plurality of images and labels corresponding to each image in the first sequence of sets of images on a first user interface of the first user device, the first sequence of sets of images determined based on the attributes associated with the first user. The instructions can cause the one or more processors to receive a selection of an image from the first sequence of sets of images, from the first user device. The instructions can cause the one or more processors to determine a second sequence of sets of images based on the selection of the image from the first sequence of sets of images at the first user device and the attributes of the second user. The instructions can cause the one or more processors to present the second sequence of sets of images and labels corresponding to the second sequence of sets of images on a second user interface on the second user device.

In some implementations, the instructions can cause the one or more processors to train a machine learning model to generate a second plurality of images and labels corresponding to the images using a training set based on the selection of the image and the attributes associated with the first user. In some implementations, the instructions can cause the one or more processors to generate, using the machine learning model, the second plurality of images and labels corresponding to the images. In some implementations, the instructions can cause the one or more processors to present the second plurality of images and labels corresponding to the images.

In some implementations, the instructions can cause the one or more processors to receive a second selection of an image from the second sequence of sets of images, from the first user device. In some implementations, the instructions can cause the one or more processors to determine a third sequence of sets of images based on the selection of the image from the second sequence of sets of images at the first user device and the attributes of the second user. In some implementations, the instructions can cause the one or more processors to present the third sequence of sets of images and labels corresponding to the third sequence images on the second user interface on the second user device.

According to an aspect of the present disclosure, a method is provided. The method includes storing, by one or more processors, a plurality of images and labels corresponding to the plurality of images in a database, each label indicating content of an image corresponding to the label. The method includes identifying, by the one or more processors, attributes associated with a first user of a first user device and a second user of a second user device. The method includes generating, by the one or more processors, a first sequence of sets of images from the plurality of images and labels corresponding to each image in the first sequence of sets of images for presentation on a first user interface of the first user device, the first sequence of sets of images determined based on the attributes associated with the first user. The method includes receiving, by the one or more processors, a selection of an image from the first sequence of sets of images, from the first user device. The method includes determining, by the one or more processors, a second sequence of sets of images based on the selection of the image from the first sequence of sets of images at the first user device and the attributes of the second user. The method includes generating, by the one or more processors, the second sequence of sets of images and labels corresponding to the second sequence of sets of images for presentation on a second user interface on the second user device.

According to other aspects of the present disclosure, the method may include one or more of the following features. The method may include training, by the one or more processors, a machine learning model to generate a second plurality of images and labels corresponding to the images using a training set based on the selection of the image and the attributes associated with the first user. The method may include generating, by the one or more processors using the machine learning model, the second plurality of images and labels corresponding to the images, and generating, by the one or more processors, the second plurality of images and labels corresponding to the images for presentation. The attributes of the first user may comprise demographic information, geographic information, and cultural information. The method may include generating, by the one or more processors, a second user interface to present the second sequence of sets images and labels, the second user interface including one or more graphical user interface elements to receive interactions with the labels. The method may include assigning, by the one or more processors, a weight to each image in the first sequence of images, the weight corresponding to a likelihood of selection by users. The method may include, in response to the selection of the image, modifying, by the one or more processors, the weight of the image to a first weight that is greater than the weight assigned to each image, and determining, by the one or more processors, the second sequence of sets of images based on the selection of the image from the first sequence of sets of images at the first user device, the attributes of the second user, and the weight assigned to each image. The method may include receiving, by the one or more processors, a second selection of an image from the second sequence of sets of images, from the first user device, determining, by the one or more processors, a third sequence of sets of images based on the selection of the image from the second sequence of sets of images at the first user device and the attributes of the second user, and generating, by the one or more processors, the third sequence of sets of images and labels corresponding to the third sequence images for presentation on the second user interface on the second user device.

According to another aspect of the present disclosure, a system is provided. The system includes one or more processors coupled with memory, the one or more processors configured to store a plurality of images and labels corresponding to the plurality of images in a database, each label indicating content of an image corresponding to the label. The one or more processors are configured to identify attributes associated with a first user of a first user device and a second user of a second user device. The one or more processors are configured to generate a first sequence of sets of images from the plurality of images and labels corresponding to each image in the first sequence of sets of images for presentation on a first user interface of the first user device, the first sequence of sets of images determined based on the attributes associated with the first user. The one or more processors are configured to receive a selection of an image from the first sequence of sets of images, from the first user device. The one or more processors are configured to determine a second sequence of sets of images based on the selection of the image from the first sequence of sets of images at the first user device and the attributes of the second user. The one or more processors are configured to generate the second sequence of sets of images and labels corresponding to the second sequence of sets of images for presentation on a second user interface on the second user device.

According to other aspects of the present disclosure, the system may include one or more of the following features. The one or more processors may be configured to train a machine learning model to generate a second plurality of images and labels corresponding to the images using a training set based on the selection of the image and the attributes associated with the first user. The one or more processors may be configured to generate, using the machine learning model, the second plurality of images and labels corresponding to the images, and generate the second plurality of images and labels corresponding to the images for presentation. The attributes of the first user may comprise demographic information, geographic information, and cultural information. The one or more processors may be configured to generate a second user interface to present the second sequence of sets images and labels, the second user interface including one or more graphical user interface elements to receive interactions with the labels. The one or more processors may be configured to assign a weight to each image in the first sequence of images, the weight corresponding to a likelihood of selection by users. The one or more processors may be configured to, in response to the selection of the image, modify the weight of the image to a first weight that is greater than the weight assigned to each image, and determine the second sequence of sets of images based on the selection of the image from the first sequence of sets of images at the first user device, the attributes of the second user, and the weight assigned to each image. The one or more processors may be configured to receive a second selection of an image from the second sequence of sets of images, from the first user device, determine a third sequence of sets of images based on the selection of the image from the second sequence of sets of images at the first user device and the attributes of the second user, and generate the third sequence of sets of images and labels corresponding to the third sequence images for presentation on the second user interface on the second user device.

According to another aspect of the present disclosure, a non-transitory computer readable medium including computer readable instructions is provided. When executed by one to more processors, the instructions cause the one or more processors to store a plurality of images and labels corresponding to the plurality of images in a database, each label indicating content of an image corresponding to the label. The instructions cause the one or more processors to identify attributes associated with a first user of a first user device and a second user of a second user device. The instructions cause the one or more processors to generate a first sequence of sets of images from the plurality of images and labels corresponding to each image in the first sequence of sets of images for presentation on a first user interface of the first user device, the first sequence of sets of images determined based on the attributes associated with the first user. The instructions cause the one or more processors to receive a selection of an image from the first sequence of sets of images, from the first user device. The instructions cause the one or more processors to determine a second sequence of sets of images based on the selection of the image from the first sequence of sets of images at the first user device and the attributes of the second user. The instructions cause the one or more processors to generate the second sequence of sets of images and labels corresponding to the second sequence of sets of images for presentation on a second user interface on the second user device.

According to other aspects of the present disclosure, the non-transitory computer readable medium may include one or more of the following features. The instructions may cause the one or more processors to train a machine learning model to generate a second plurality of images and labels corresponding to the images using a training set based on the selection of the image and the attributes associated with the first user. The instructions may cause the one or more processors to generate, using the machine learning model, the second plurality of images and labels corresponding to the images, and generate the second plurality of images and labels corresponding to the images for presentation. The instructions may cause the one or more processors to receive a second selection of an image from the second sequence of sets of images, from the first user device, determine a third sequence of sets of images based on the selection of the image from the second sequence of sets of images at the first user device and the attributes of the second user, and generate the third sequence of sets of images and labels corresponding to the third sequence images for presentation on the second user interface on the second user device.

According to an aspect of the present disclosure, a method is provided. The method includes storing, by one or more processors, a plurality of images and labels corresponding to the plurality of images in a database, each label indicating content of an image corresponding to the label. The method includes identifying, by the one or more processors, attributes associated with a first user of a first user device and a second user of a second user device. The method includes presenting, by the one or more processors, a first sequence of sets of images from the plurality of images and labels corresponding to each image in the first sequence of sets of images on a first user interface of the first user device, the first sequence of sets of images determined based on the attributes associated with the first user. The method includes receiving, by the one or more processors, a selection of an image from the first sequence of sets of images, from the first user device. The method includes determining, by the one or more processors, a second sequence of sets of images based on the selection of the image from the first sequence of sets of images at the first user device and the attributes of the second user. The method includes presenting, by the one or more processors, the second sequence of sets of images and labels corresponding to the second sequence of sets of images on a second user interface on the second user device.

According to other aspects of the present disclosure, the method may include one or more of the following features. The method may include training, by the one or more processors, a machine learning model to generate a second plurality of images and labels corresponding to the images using a training set based on the selection of the image and the attributes associated with the first user. The method may include generating, by the one or more processors using the machine learning model, the second plurality of images and labels corresponding to the images, and presenting, by the one or more processors, the second plurality of images and labels corresponding to the images. The attributes of the first user may comprise demographic information, geographic information, and cultural information. The method may include generating, by the one or more processors, a second user interface to present the second sequence of sets images and labels, the second user interface including one or more graphical user interface elements to receive interactions with the labels. The method may include assigning, by the one or more processors, a weight to each image in the first sequence of images, the weight corresponding to a likelihood of selection by the user. The method may include, in response to the selection of the image modifying, by the one or more processors, the weight of the image to a first weight that is greater than the weight assigned to each image, and determining, by the one or more processors, the second sequence of sets of images based on the selection of the image from the first sequence of sets of images at the first user device, the attributes of the second user, and the weight assigned to each image. The method may include receiving, by the one or more processors, a second selection of an image from the second sequence of sets of images, from the first user device, determining, by the one or more processors, a third sequence of sets of images based on the selection of the image from the second sequence of sets of images at the first user device and the attributes of the second user, and presenting, by the one or more processors, the third sequence of sets of images and labels corresponding to the third sequence images on the second user interface on the second user device.

According to another aspect of the present disclosure, a system is provided. The system includes one or more processors coupled with memory. The one or more processors are configured to store a plurality of images and labels corresponding to the plurality of images in a database, each label indicating content of an image corresponding to the label. The one or more processors are configured to identify attributes associated with a first user of a first user device and a second user of a second user device. The one or more processors are configured to present a first sequence of sets of images from the plurality of images and labels corresponding to each image in the first sequence of sets of images on a first user interface of the first user device, the first sequence of sets of images determined based on the attributes associated with the first user. The one or more processors are configured to receive a selection of an image from the first sequence of sets of images, from the first user device. The one or more processors are configured to determine a second sequence of sets of images based on the selection of the image from the first sequence of sets of images at the first user device and the attributes of the second user. The one or more processors are configured to present the second sequence of sets of images and labels corresponding to the second sequence of sets of images on a second user interface on the second user device.

According to other aspects of the present disclosure, the system may include one or more of the following features. The one or more processors may be configured to train a machine learning model to generate a second plurality of images and labels corresponding to the images using a training set based on the selection of the image and the attributes associated with the first user. The one or more processors may be configured to generate, using the machine learning model, the second plurality of images and labels corresponding to the images, and present the second plurality of images and labels corresponding to the images. The attributes of the first user may comprise demographic information, geographic information, and cultural information. The one or more processors may be configured to generate a second user interface to present the second sequence of sets images and labels, the second user interface including one or more graphical user interface elements to receive interactions with the labels. The one or more processors may be configured to assign a weight to each image in the first sequence of images, the weight corresponding to a likelihood of selection by the user. The one or more processors may be configured to, in response to the selection of the image, modify the weight of the image to a first weight that is greater than the weight assigned to each image, and determine the second sequence of sets of images based on the selection of the image from the first sequence of sets of images at the first user device, the attributes of the second user, and the weight assigned to each image. The one or more processors may be configured to receive a second selection of an image from the second sequence of sets of images, from the first user device, determine a third sequence of sets of images based on the selection of the image from the second sequence of sets of images at the first user device and the attributes of the second user, and present the third sequence of sets of images and labels corresponding to the third sequence images on the second user interface on the second user device.

According to another aspect of the present disclosure, a non-transitory computer readable medium including computer readable instructions is provided. When executed by one to more processors, the instructions cause the one or more processors to store a plurality of images and labels corresponding to the plurality of images in a database, each label indicating content of an image corresponding to the label. The instructions cause the one or more processors to identify attributes associated with a first user of a first user device and a second user of a second user device. The instructions cause the one or more processors to present a first sequence of sets of images from the plurality of images and labels corresponding to each image in the first sequence of sets of images on a first user interface of the first user device, the first sequence of sets of images determined based on the attributes associated with the first user. The instructions cause the one or more processors to receive a selection of an image from the first sequence of sets of images, from the first user device. The instructions cause the one or more processors to determine a second sequence of sets of images based on the selection of the image from the first sequence of sets of images at the first user device and the attributes of the second user. The instructions cause the one or more processors to present the second sequence of sets of images and labels corresponding to the second sequence of sets of images on a second user interface on the second user device.

According to other aspects of the present disclosure, the non-transitory computer readable medium may include one or more of the following features. The instructions may cause the one or more processors to train a machine learning model to generate a second plurality of images and labels corresponding to the images using a training set based on the selection of the image and the attributes associated with the first user. The instructions may cause the one or more processors to generate, using the machine learning model, the second plurality of images and labels corresponding to the images, and present the second plurality of images and labels corresponding to the images. The instructions may cause the one or more processors to receive a second selection of an image from the second sequence of sets of images, from the first user device, determine a third sequence of sets of images based on the selection of the image from the second sequence of sets of images at the first user device and the attributes of the second user, and present the third sequence of sets of images and labels corresponding to the third sequence images on the second user interface on the second user device.

According to an aspect of the present disclosure, a method is provided. The method includes storing, by one or more processors, a plurality of images and labels corresponding to the plurality of images in a database, each label indicating content of an image corresponding to the label. The method includes identifying, by the one or more processors, attributes associated with a first user of a first user device and a second user of a second user device. The method includes presenting, by the one or more processors, a first sequence of sets of images from the plurality of images and labels corresponding to each image in the first sequence of sets of images on a first user interface of the first user device, the first sequence of sets of images determined based on the attributes associated with the first user. The method includes receiving, by the one or more processors, a selection of an image from the first sequence of sets of images, from the first user device. The method includes determining, by the one or more processors, a second sequence of sets of images based on the selection of the image from the first sequence of sets of images at the first user device and the attributes of the second user. The method includes presenting, by the one or more processors, the second sequence of sets of images and labels corresponding to the second sequence of sets of images on a second user interface on the second user device.

According to other aspects of the present disclosure, the method may include one or more of the following features. The method may include training, by the one or more processors, a machine learning model to generate a second plurality of images and labels corresponding to the images using a training set based on the selection of the image and the attributes associated with the first user. The method may include generating, by the one or more processors using the machine learning model, the second plurality of images and labels corresponding to the images, and presenting, by the one or more processors, the second plurality of images and labels corresponding to the images. The attributes of the first user may comprise demographic information, geographic information, and cultural information. The method may include generating, by the one or more processors, a second user interface to present the second sequence of sets images and labels, the second user interface including one or more graphical user interface elements to receive interactions with the labels. The method may include assigning, by the one or more processors, a weight to each image in the first sequence of images, the weight corresponding to a likelihood of selection by the user. The method may include, in response to the selection of the image modifying, by the one or more processors, the weight of the image to a first weight that is greater than the weight assigned to each image, and determining, by the one or more processors, the second sequence of sets of images based on the selection of the image from the first sequence of sets of images at the first user device, the attributes of the second user, and the weight assigned to each image. The method may include receiving, by the one or more processors, a second selection of an image from the second sequence of sets of images, from the first user device, determining, by the one or more processors, a third sequence of sets of images based on the selection of the image from the second sequence of sets of images at the first user device and the attributes of the second user, and presenting, by the one or more processors, the third sequence of sets of images and labels corresponding to the third sequence images on the second user interface on the second user device.

According to another aspect of the present disclosure, a system is provided. The system includes one or more processors coupled with memory. The one or more processors are configured to store a plurality of images and labels corresponding to the plurality of images in a database, each label indicating content of an image corresponding to the label. The one or more processors are configured to identify attributes associated with a first user of a first user device and a second user of a second user device. The one or more processors are configured to present a first sequence of sets of images from the plurality of images and labels corresponding to each image in the first sequence of sets of images on a first user interface of the first user device, the first sequence of sets of images determined based on the attributes associated with the first user. The one or more processors are configured to receive a selection of an image from the first sequence of sets of images, from the first user device. The one or more processors are configured to determine a second sequence of sets of images based on the selection of the image from the first sequence of sets of images at the first user device and the attributes of the second user. The one or more processors are configured to present the second sequence of sets of images and labels corresponding to the second sequence of sets of images on a second user interface on the second user device.

According to other aspects of the present disclosure, the system may include one or more of the following features. The one or more processors may be configured to train a machine learning model to generate a second plurality of images and labels corresponding to the images using a training set based on the selection of the image and the attributes associated with the first user. The one or more processors may be configured to generate, using the machine learning model, the second plurality of images and labels corresponding to the images, and present the second plurality of images and labels corresponding to the images. The attributes of the first user may comprise demographic information, geographic information, and cultural information. The one or more processors may be configured to generate a second user interface to present the second sequence of sets images and labels, the second user interface including one or more graphical user interface elements to receive interactions with the labels. The one or more processors may be configured to assign a weight to each image in the first sequence of images, the weight corresponding to a likelihood of selection by the user. The one or more processors may be configured to, in response to the selection of the image, modify the weight of the image to a first weight that is greater than the weight assigned to each image, and determine the second sequence of sets of images based on the selection of the image from the first sequence of sets of images at the first user device, the attributes of the second user, and the weight assigned to each image. The one or more processors may be configured to receive a second selection of an image from the second sequence of sets of images, from the first user device, determine a third sequence of sets of images based on the selection of the image from the second sequence of sets of images at the first user device and the attributes of the second user, and present the third sequence of sets of images and labels corresponding to the third sequence images on the second user interface on the second user device.

According to another aspect of the present disclosure, a non-transitory computer readable medium including computer readable instructions is provided. When executed by one to more processors, the instructions cause the one or more processors to store a plurality of images and labels corresponding to the plurality of images in a database, each label indicating content of an image corresponding to the label. The instructions cause the one or more processors to identify attributes associated with a first user of a first user device and a second user of a second user device. The instructions cause the one or more processors to present a first sequence of sets of images from the plurality of images and labels corresponding to each image in the first sequence of sets of images on a first user interface of the first user device, the first sequence of sets of images determined based on the attributes associated with the first user. The instructions cause the one or more processors to receive a selection of an image from the first sequence of sets of images, from the first user device. The instructions cause the one or more processors to determine a second sequence of sets of images based on the selection of the image from the first sequence of sets of images at the first user device and the attributes of the second user. The instructions cause the one or more processors to present the second sequence of sets of images and labels corresponding to the second sequence of sets of images on a second user interface on the second user device.

According to other aspects of the present disclosure, the non-transitory computer readable medium may include one or more of the following features. The instructions may cause the one or more processors to train a machine learning model to generate a second plurality of images and labels corresponding to the images using a training set based on the selection of the image and the attributes associated with the first user. The instructions may cause the one or more processors to generate, using the machine learning model, the second plurality of images and labels corresponding to the images, and present the second plurality of images and labels corresponding to the images. The instructions may cause the one or more processors to receive a second selection of an image from the second sequence of sets of images, from the first user device, determine a third sequence of sets of images based on the selection of the image from the second sequence of sets of images at the first user device and the attributes of the second user, and present the third sequence of sets of images and labels corresponding to the third sequence images on the second user interface on the second user device.

According to an aspect of the present disclosure, a method is provided. The method includes receiving, by one or more processors for each of a plurality of first users, a set of user configurations and a first set of attributes associated with a first user. The method includes generating, by the one or more processors for each of the plurality of first users, a first profile comprising the set of user configurations and the first set of attributes associated with the first user. The method includes generating, by the one or more processors, a sequence of sets of images for presentation on a user interface at a client device accessing a second profile, each image corresponding to a user configuration and the second profile corresponding to a second set of attributes associated with a second user. The method includes receiving, by the one or more processors from the user interface, a selection of an image from each set of the sequence of sets. The method includes executing, by the one or more processors, a generative machine learning model using the second set of attributes associated with the second user and identifications of the selections of the images to generate an identification of content for the second user, the generative machine learning model trained based on first profiles for the plurality of first users and image selections by the plurality of first users using the first profiles. The method includes revising, by the one or more processors, the user interface presented at the client device to include the identification of the content for the second user.

According to other aspects of the present disclosure, the method may include one or more of the following features. The method may include training, by the one or more processors, the generative machine learning model to generate the recommendation of content for the second user using a training dataset, the training dataset comprising the first profiles for the plurality of first users. The method may include generating, by the one or more processors, the identification of the content for the second user based on the first profile for the first user. The method may include extracting, by the one or more processors from a data repository, the set of user configurations from the plurality of first users, and storing, by the one or more processors in the data repository, the second profile for the second user and an association between the first profile and the second profile. The method may include executing, by the one or more processors, the generative machine learning model using a third profile comprising a third set of attributes associated with a third user to generate a recommendation of content for the third user, the generative machine learning model trained based on the first profile and the second profile, and generating, by the one or more processors, a second user interface containing the recommendation of content for the third user for presentation at a second client device. The method may include identifying, by the one or more processors, a subset of the plurality of users according to the association, the subset including one or more users with at least one similarity in the set of user configurations. The generative machine learning model may be trained using at least one of supervised or unsupervised learning.

According to another aspect of the present disclosure, a system is provided. The system includes one or more processors coupled with memory, the one or more processors configured to receive for each of a plurality of first users, a set of user configurations and a first set of attributes associated with a first user. The one or more processors are configured to generate for each of the plurality of first users, a first profile comprising the set of user configurations and the first set of attributes associated with the first user. The one or more processors are configured to generate a sequence of sets of images for presentation on a user interface at a client device accessing a second profile, each image corresponding to a user configuration and the second profile corresponding to a second set of attributes associated with a second user. The one or more processors are configured to receive, from the user interface, a selection of an image from each set of the sequence of sets. The one or more processors are configured to execute a generative machine learning model using the second set of attributes associated with the second user and identifications of the selections of the images to generate an identification content for the second user, the generative machine learning model trained based on first profiles for the plurality of first users and image selections by the plurality of first users using the first profiles. The one or more processors are configured to revise the user interface presented at the client device to include the identification of the content for the second user.

According to other aspects of the present disclosure, the system may include one or more of the following features. The one or more processors may be configured to train the generative machine learning model to generate the identification of the content for the second user using a training dataset, the training dataset comprising the first profiles for the plurality of first users. The one or more processors may be configured to generate the recommendation of content for the second user based on the first profile for the first user. The one or more processors may be configured to extract, from a data repository, the set of user configurations from the plurality of first users, and store, in the data repository, the second profile for the second user and an association between the first profile and the second profile. The one or more processors may be configured to execute the generative machine learning model using a third profile comprising a third set of attributes associated with a third user to generate a recommendation of content for the third user, the generative machine learning model trained based on the first profile and the second profile, and generate a second user interface containing the recommendation of content for the third user for presentation at a second client device. The one or more processors may be configured to identify a subset of the plurality of users according to the association, the subset including one or more users with at least one similarity in the set of user configurations.

According to another aspect of the present disclosure, a non-transitory computer readable medium including computer readable instructions is provided. When executed by one to more processors, the instructions cause the one or more processors to receive for each of a plurality of first users, a set of user configurations and a first set of attributes associated with a first user. The instructions cause the one or more processors to generate for each of the plurality of first users, a first profile comprising the set of user configurations and the first set of attributes associated with the first user. The instructions cause the one or more processors to generate a sequence of sets of images for presentation on a user interface at a client device accessing a second profile, each image corresponding to a user configuration and the second profile corresponding to a second set of attributes associated with a second user. The instructions cause the one or more processors to receive, from the user interface, a selection of an image from each set of the sequence of sets. The instructions cause the one or more processors to execute a generative machine learning model using the second set of attributes associated with the second user and identifications of the selections of the images to generate an identification content for the second user, the generative machine learning model trained based on first profiles for the plurality of first users and image selections by the plurality of first users using the first profiles. The instructions cause the one or more processors to revise the user interface presented at the client device to include the identification of the content for the second user.

According to other aspects of the present disclosure, the non-transitory computer readable medium may include one or more of the following features. The instructions may cause the one or more processors to train the generative machine learning model to generate the identification of the content for the second user using a training dataset, the training dataset comprising the first profiles for the plurality of first users. The instructions may cause the one or more processors to generate the identification of the content for the second user based on the first profile for the first user. The instructions may cause the one or more processors to extract, from a data repository, the set of user configurations from the plurality of first users, and store, in the data repository, the second profile for the second user and an association between the first profile and the second profile. The instructions may cause the one or more processors to execute the generative machine learning model using a third profile comprising a third set of attributes associated with a third user to generate a recommendation of content for the third user, the generative machine learning model trained based on the first profile and the second profile, and generate a second user interface containing the recommendation of content for the third user for presentation at the second client device. The instructions may cause the one or more processors to identify a subset of the plurality of users according to the association, the subset including one or more users with at least one similarity in the set of user configurations. The generative machine learning model may be trained using at least one of supervised or unsupervised learning.

According to another aspect of the present disclosure, a method is provided. The method includes receiving, by one or more processors, an utterance comprising a plurality of words from a user device, the utterance transcribed based on audio data of an individual speaking into a microphone. The method includes executing, by the one or more processors, a natural language processing model to extract a plurality of keywords from the utterance. The method includes executing, by the one or more processors, a machine learning model using the extracted plurality of keywords from the utterance to generate one or more user configurations, the machine learning model trained to generate the one or more user configurations based on a training set of keywords mapped to user configurations. The method includes generating, by the one or more processors, the one or more user configurations for presentation on a user interface of the user device with mappings between the one or more user configurations and corresponding keywords extracted from the utterance.

According to other aspects of the present disclosure, the method may include one or more of the following features. The method may include extracting, by the one or more processors from a data repository, a plurality of expected keywords corresponding to the one or more user configurations of the individual, and training, by the one or more processors, the machine learning model to generate the user configurations of the individual based at least on a comparison of the extracted plurality of keywords and the plurality of expected keywords. The method may include detecting, by the one or more processors, the individual speaking based on a comparison of the utterances of the user and a stored audio data of the user, and responsive to the comparison satisfying a threshold, identifying, by the one or more processors, the individual speaking the utterances. The method may further include receiving, by the one or more processors from the user device, feedback associated with the generated images and labels, the feedback indicating one or more weights to improve the neural network; and updating, by the one or more processors using the feedback, the neural network by modifying the one or more weights of the neural network. The method may further include pseudo-randomly generating, by the one or more processors, the sequence of sets of images using a plurality of identifiers, wherein each identifier of the plurality of identifiers corresponds to a respective image within a data repository.

The method may include storing the plurality of key words associated with the identified individual within a profile of the data repository. The method may include storing, by the one or more processors in the data repository, the plurality of keywords corresponding to a profile representing the individual speaking. The method may include modifying, by the one or more processors, the one or more user configurations of the individual speaking based on second utterance of the individual, the second utterance different from the utterance. The method may include assigning, by the one or more processors, a weight to each of the plurality of keywords based on the utterance of the individual, and executing, by the one or more processors, the machine learning model using the plurality of keywords according to the weight. The natural language processing model may be at least one of a Rule-based Model, a Statistical Model, or a Deep Learning Model. The method may include generating, by the one or more processors using the machine learning model, one or more user configurations for the individual.

According to an aspect of the present disclosure, a method is provided. The method includes storing, by one or more processors, a plurality of images and labels corresponding to the plurality of images in a database, each label indicating content of an image corresponding to the label. The method includes identifying, by the one or more processors, attributes associated with a first user of a first user device and a second user of a second user device. The method includes presenting, by the one or more processors, a first sequence of sets of images from the plurality of images and labels corresponding to each image in the first sequence of sets of images on a first user interface of the first user device, the first sequence of sets of images determined based on the attributes associated with the first user. The method includes receiving, by the one or more processors, a selection of an image from the first sequence of sets of images, from the first user device. The method includes determining, by the one or more processors, a second sequence of sets of images based on the selection of the image from the first sequence of sets of images at the first user device and the attributes of the second user. The method includes presenting, by the one or more processors, the second sequence of sets of images and labels corresponding to the second sequence of sets of images on a second user interface on the second user device.

According to other aspects of the present disclosure, the method may include one or more of the following features. The method may include training, by the one or more processors, a machine learning model to generate a second plurality of images and labels corresponding to the images using a training set based on the selection of the image and the attributes associated with the first user. The method may include generating, by the one or more processors using the machine learning model, the second plurality of images and labels corresponding to the images, and presenting, by the one or more processors, the second plurality of images and labels corresponding to the images. The attributes of the first user may comprise demographic information, geographic information, and cultural information. The method may include generating, by the one or more processors, a second user interface to present the second sequence of sets images and labels, the second user interface including one or more graphical user interface elements to receive interactions with the labels. The method may include assigning, by the one or more processors, a weight to each image in the first sequence of images, the weight corresponding to a likelihood of selection by the user. The method may include, in response to the selection of the image modifying, by the one or more processors, the weight of the image to a first weight that is greater than the weight assigned to each image, and determining, by the one or more processors, the second sequence of sets of images based on the selection of the image from the first sequence of sets of images at the first user device, the attributes of the second user, and the weight assigned to each image. The method may include receiving, by the one or more processors, a second selection of an image from the second sequence of sets of images, from the first user device, determining, by the one or more processors, a third sequence of sets of images based on the selection of the image from the second sequence of sets of images at the first user device and the attributes of the second user, and presenting, by the one or more processors, the third sequence of sets of images and labels corresponding to the third sequence images on the second user interface on the second user device.

According to another aspect of the present disclosure, a system is provided. The system includes one or more processors coupled with memory, the one or more processors configured to store a plurality of images and labels corresponding to the plurality of images in a database, each label indicating content of an image corresponding to the label. The one or more processors are configured to identify attributes associated with a first user of a first user device and a second user of a second user device. The one or more processors are configured to present a first sequence of sets of images from the plurality of images and labels corresponding to each image in the first sequence of sets of images on a first user interface of the first user device, the first sequence of sets of images determined based on the attributes associated with the first user. The one or more processors are configured to receive a selection of an image from the first sequence of sets of images, from the first user device. The one or more processors are configured to determine a second sequence of sets of images based on the selection of the image from the first sequence of sets of images at the first user device and the attributes of the second user. The one or more processors are configured to present the second sequence of sets of images and labels corresponding to the second sequence of sets of images on a second user interface on the second user device.

According to other aspects of the present disclosure, the system may include one or more of the following features. The one or more processors may be configured to train a machine learning model to generate a second plurality of images and labels corresponding to the images using a training set based on the selection of the image and the attributes associated with the first user. The one or more processors may be configured to generate, using the machine learning model, the second plurality of images and labels corresponding to the images, and present the second plurality of images and labels corresponding to the images. The attributes of the first user may comprise demographic information, geographic information, and cultural information. The one or more processors may be configured to generate a second user interface to present the second sequence of sets images and labels, the second user interface including one or more graphical user interface elements to receive interactions with the labels. The one or more processors may be configured to assign a weight to each image in the first sequence of images, the weight corresponding to a likelihood of selection by the user. The one or more processors may be configured to, in response to the selection of the image, modify the weight of the image to a first weight that is greater than the weight assigned to each image, and determine the second sequence of sets of images based on the selection of the image from the first sequence of sets of images at the first user device, the attributes of the second user, and the weight assigned to each image. The one or more processors may be configured to receive a second selection of an image from the second sequence of sets of images, from the first user device, determine a third sequence of sets of images based on the selection of the image from the second sequence of sets of images at the first user device and the attributes of the second user, and present the third sequence of sets of images and labels corresponding to the third sequence images on the second user interface on the second user device.

According to another aspect of the present disclosure, a non-transitory computer readable medium including computer readable instructions is provided. When executed by one to more processors, the instructions cause the one or more processors to store a plurality of images and labels corresponding to the plurality of images in a database, each label indicating content of an image corresponding to the label. The instructions cause the one or more processors to identify attributes associated with a first user of a first user device and a second user of a second user device. The instructions cause the one or more processors to present a first sequence of sets of images from the plurality of images and labels corresponding to each image in the first sequence of sets of images on a first user interface of the first user device, the first sequence of sets of images determined based on the attributes associated with the first user. The instructions cause the one or more processors to receive a selection of an image from the first sequence of sets of images, from the first user device. The instructions cause the one or more processors to determine a second sequence of sets of images based on the selection of the image from the first sequence of sets of images at the first user device and the attributes of the second user. The instructions cause the one or more processors to present the second sequence of sets of images and labels corresponding to the second sequence of sets of images on a second user interface on the second user device.

According to other aspects of the present disclosure, the non-transitory computer readable medium may include one or more of the following features. The instructions may cause the one or more processors to train a machine learning model to generate a second plurality of images and labels corresponding to the images using a training set based on the selection of the image and the attributes associated with the first user. The instructions may cause the one or more processors to generate, using the machine learning model, the second plurality of images and labels corresponding to the images, and present the second plurality of images and labels corresponding to the images. The instructions may cause the one or more processors to receive a second selection of an image from the second sequence of sets of images, from the first user device, determine a third sequence of sets of images based on the selection of the image from the second sequence of sets of images at the first user device and the attributes of the second user, and present the third sequence of sets of images and labels corresponding to the third sequence images on the second user interface on the second user device.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What we claim is:

1. A method for contextual image generation, comprising:
storing, by one or more processors, a plurality of images and labels corresponding to the plurality of images, each label indicating content of an image corresponding to the label;
generating, by the one or more processors, a sequence of sets of images from the plurality of images for presentation on a user interface at a user device;
receiving, by the one or more processors, a selection of an image for each set of the sets of images from the user device;
determining, by the one or more processors, a predicted user configuration for a user of the user device based on the selections of the images and the labels corresponding to the selected images;
creating, by the one or more processors, a training set at least comprising the selections of the images, the labels corresponding to the selected images, the predicted user configuration for the user, and an expected user configuration for the user; and
training, by the one or more processors using the training set, a neural network to generate images and labels corresponding to the images based at least on the selections of the images, the labels corresponding to the selected images, and a comparison of the predicted user configuration and the expected user configuration.

2. The method of claim 1, further comprising:
executing, by the one or more processors, the trained neural network to generate a second sequence of sets images;
generating the second sequence of sets of images for presentation on a second user interface at a second user device;
receiving, by the one or more processors, a second selection of an image for each set of the second sequence of sets of images from the second user device;
determining, by the one or more processors, a second predicted user configuration for a second user of the second user device based on the second selections of the images; and
generating, by the one or more processors, a record comprising the second predicted user configuration.

3. The method of claim 1, further comprising:
identifying, by the one or more processors, location information associated with the user device; and
training, by the one or more processors, the neural network to generate images and labels corresponding to the images using the training set based at least on the selections of images, the labels corresponding to the selected images, the location information associated with the user device, and the comparison of the predicted user configuration and the expected user configuration.

4. The method of claim 3, wherein the location information indicates at least one of school district information, state information, or a geographical location.

5. The method of claim 3, further comprising:
inputting, by the one or more processors, the location information of computing devices located at one or more locations to the neural network to generate images corresponding to each location of the one or more locations; and
storing, by the one or more processors, the generated images based on the location information associated with each generated image.

6. The method of claim 3, further comprising:
generating, by the one or more processors, a user interface configured to present the sequence of sets of images and receive interactions indicating the selection of the image from the sets of images.

7. The method of claim 3, further comprising:
determining, by the one or more processors, a second predicted user configuration for a second user based on the location information of the user device and the predicted user configuration of the user.

8. The method of claim 1, further comprising:
receiving, by the one or more processors from the user device, feedback associated with the generated images and labels, the feedback indicating one or more weights to improve the neural network; and
updating, by the one or more processors using the feedback, the neural network by modifying the one or more weights of the neural network.

9. The method of claim 1, further comprising:
pseudo-randomly generating, by the one or more processors, the sequence of sets of images using a plurality of identifiers, wherein each identifier of the plurality of identifiers corresponds to a respective image within a data repository.

10. A system for contextual imaging generation, comprising:
one or more processors coupled with memory, the one or more processors configured to:
store a plurality of images and labels corresponding to the plurality of images, each label indicating content of an image corresponding to the label;
generating a sequence of sets of images from the plurality of images for presentation on a user interface at a user device;
receive a selection of an image for each set of the sets of images from the user device;
determine a predicted user configuration for a user of the user device based on the selections of the images and the labels corresponding to the selected images;
create a training set at least comprising the selections of the images, the labels corresponding to the selected images, the predicted user configuration for the user, and an expected user configuration for the user; and
train, using the training set, a neural network to generate images and labels corresponding to the images based at least on the selections of the images, the labels corresponding to the selected images, and a comparison of the predicted user configuration and the expected user configuration.

11. The system of claim 1, the one or more processors are configured to:
execute the trained neural network to generate a second sequence of sets images;
generate the second sequence of sets of images for presentation on a second user interface at a second user device;
receive a second selection of an image for each set of the second sequence of sets of images from the second user device;
determine a second predicted user configuration for a second user of the second user device based on the second selections of the images; and
generate a record comprising the second predicted user configuration.

12. The system of claim 10, the one or more processors are configured to:
identify location information associated with the user device; and
train the neural network to generate images and labels corresponding to the images using the training set based at least on the selections of images, the labels corresponding to the selected images, the location information associated with the user device, and the comparison of the predicted user configuration and the expected user configuration.

13. The system of claim 12, wherein the location information indicates at least one of school district information, state information, or geographical location.

14. The system of claim 12, the one or more processors are configured to:
input the location information of computing devices located at one or more locations to the neural network to generate images corresponding to each location of the one or more locations; and
store the generated images based on the location information associated with each generated image.

15. The system of claim 12, the one or more processors are configured to:
generate a user interface configured to present the sequence of sets of images and receive interactions indicating the selection of the image from the sets of images.

16. The system of claim 12, the one or more processors are configured to:
determine a second predicted user configuration for a second user based on the location information of the user device and the predicted user configuration of the user

17. The system of claim 10, the one or more processors are configured to:
receive, from the user device, feedback associated with the generated images and labels, the feedback indicating one or more weights to improve the neural network; and
update, using the feedback, the neural network by modifying the one or more weights of the neural network.

18. The system of claim 10, the one or more processors are configured to:
pseudo-randomly generate the sequence of sets of images using a plurality of identifiers, wherein each identifier of the plurality of identifiers corresponds to a respective image within a data repository.

19. A non-transitory computer readable medium including computer readable instructions, that when executed by one to more processors, cause the one or more processors to:
store a plurality of images and labels corresponding to the plurality of images, each label indicating content of an image corresponding to the label;
generate a sequence of sets of images from the plurality of images for presentation on a user interface at a user device;
receive a selection of an image for each set of the sets of images from the user device;
determine a predicted user configuration for a user of the user device based on the selections of the images and the labels corresponding to the selected images;
create a training set at least comprising the selections of the images, the labels corresponding to the selected images, the predicted user configuration for the user, and an expected user configuration for the user; and
train, using the training set, a neural network to generate images and labels corresponding to the images based at least on the selections of the images, the labels corresponding to the selected images, and a comparison of the predicted user configuration and the expected user configuration.

20. The non-transitory computer readable medium of claim 19, wherein the instructions cause the one or more processors to:
execute the trained neural network to generate a second sequence of sets images;
generate the second sequence of sets of images for presentation on a second user interface at a second user device;
receive, a second selection of an image for each set of the second sequence of sets of images from the second user device;
determine a second predicted user configuration for a second user of the second user device based on the second selections of the images; and
generate a record comprising the second predicted user configuration.
